(19) United States
(12) Patent Application Publication
(10) Pub. No.: US 2026/0099901 A1
(43) Pub. Date: Apr. 9, 2026

(54) IMAGE DETECTION METHOD, MODEL TRAINING METHOD, AND ELECTRONIC DEVICE

(71) Applicant: BEIJING BAIDU NETCOM SCIENCE TECHNOLOGY CO., LTD., Beijing (CN)

(72) Inventors: Jialei Cui, Beijing (CN); Yanzhe Li, Beijing (CN); Lei Gao, Beijing (CN); Qingyu Meng, Beijing (CN); Yuanwen Chen, Beijing (CN); Chenfu Bao, Beijing (CN)

(73) Assignee: BEIJING BAIDU NETCOM SCIENCE TECHNOLOGY CO., LTD., Beijing (CN)

(21) Appl. No.: 19/415,679

(22) Filed: Dec. 10, 2025

(30) Foreign Application Priority Data
Sep. 19, 2025 (CN) 202511350387.8

(51) Int. Cl. G06T 5/60; G06T 3/40; G06T 5/70; G06T 7/00; G06T 7/73

(52) U.S. Cl. CPC G06T 5/60; G06T 3/40; G06T 5/70; G06T 7/0002; G06T 7/73; G06T 2207/20076; G06T 2207/20081; G06T 2207/30168

(57) ABSTRACT

An image detection method includes: calling a teacher model to generate a first reconstructed image according to an initial image; calling a student model to generate a second reconstructed image according to the initial image, in which the student model is trained based on the teacher model and has a capability to detect an abnormal region in the image; and determining a position of the abnormal region in the initial image according to a reconstruction error between the initial image and the first reconstructed image and a reconstruction error between the initial image and the second reconstructed image.

### CROSS REFERENCE TO RELATED APPLICATION

This application is based on and claims priority to Chinese Patent Application No. 202511350387.8, filed on Sep. 19, 2025, the entire content of which is hereby incorporated by reference.

### TECHNICAL FIELD

The disclosure relates to the technical field such as artificial intelligence (AI), image processing or large model, in particular to an image detection method, a model training method, and an electronic device.

### BACKGROUND

In related arts, image anomaly detection mainly relies on expertise and specially trained detection networks, which has a low detection accuracy, requires massive labeled data, and has poor generalization capabilities.

### SUMMARY

According to a first aspect of the disclosure, an image detection method is provided. The method includes: calling a teacher model to generate a first reconstructed image according to an initial image; calling a student model to generate a second reconstructed image according to the initial image, in which the student model is trained based on the teacher model and has a capability to detect an abnormal region in the image; and determining a position of the abnormal region in the initial image according to a reconstruction error between the initial image and the first reconstructed image and a reconstruction error between the initial image and the second reconstructed image.

According to a second aspect of the disclosure, an electronic device is provided. The electronic device includes: at least one processor and a memory communicatively connected with the at least one processor. The memory stores instructions executable by the at least one processor, and when the instructions are executed by the at least one processor, the at least one processor is caused to implement the method described above in the disclosure.

According to a third aspect of the disclosure, a non-transitory computer-readable storage medium for storing computer instructions is provided. The computer instructions are used to cause a computer to implement the method described above in the disclosure.

It should be understood that the content described in this section is not intended to identify key or important features of the embodiments of the disclosure, nor is it intended to limit the scope of the disclosure. Additional features of the disclosure will be easily understood from the following description.

### BRIEF DESCRIPTION OF THE DRAWINGS

The accompanying drawings are used to better understand the solution and do not constitute a limitation to the disclosure, in which:

FIG. 1 is a flowchart of an image detection method provided by an embodiment of the disclosure.

FIG. 2 is a flowchart of another image detection method provided by an embodiment of the disclosure.

FIG. 3 is a schematic diagram of a principle of an image detection method provided by an embodiment of the disclosure.

FIG. 4 is a schematic diagram of an error analysis result provided by an embodiment of the disclosure.

FIG. 5 is a flowchart of a model training method provided by an embodiment of the disclosure.

FIG. 6 is a schematic diagram of another model training method provided by an embodiment of the disclosure.

FIG. 7 is a schematic diagram of yet another model training method provided by an embodiment of the disclosure.

FIG. 8 is a schematic structural diagram of an image detection apparatus provided by an embodiment of the disclosure.

FIG. 9 is a schematic structural diagram of a model training apparatus provided by an embodiment of the disclosure.

FIG. 10 is a schematic block diagram of an example electronic device 1000 that may be used to implement embodiments of the disclosure.

### DETAILED DESCRIPTION

The example embodiments of the disclosure are illustrated in combination with the accompanying drawings, which includes various details of the embodiments of the disclosure to aid in understanding, and should be considered merely exemplary. Those skilled in the art understood that various changes and modifications of the embodiments described herein can be made without departing from the scope and spirit of the disclosure. For the sake of clarity and brevity, descriptions of well-known functions and structures are omitted from the following descriptions.

With the popularization of digital office, tampered document images are rapidly increasing. In related arts, image anomaly detection mainly relies on expertise and specially trained detection networks, which has a low detection accuracy, requires massive labeled data, and has poor generalization capabilities. For example, in the related arts, image anomaly detection includes the following methods.

### 1. Image Anomaly Detection Based on Statistical Image Features and Signal Processing

Early image anomaly detection technique mainly refers to a method based on statistical image features and signal processing. This type of method identifies abnormal traces by analyzing underlying features of an image, including joint photographic experts group (JPEG) compression block effectiveness analysis, re-sampling trace detection, and color filter array (CFA) consistency analysis.

Although the method may effectively detect specific anomaly types, it needs to design specific detection algorithms for different anomaly types, thus lacking universality. For example, in terms of detecting the tampered document images, the method primarily focuses on geometric features of text, stroke consistency, character spacing and other features, and detects tampering by manually analyzing file layout patterns, font features, and printing/scanning traces. This entire process heavily relies on manually designed features, which makes it difficult to detect carefully crafted tampering.

### 2. Deep Learning-Based Image Anomaly Detection

Recently, deep learning techniques have been widely applied to image anomaly detection.

For example, the related arts have proposed a two-stream network structure, which is capable of extracting abnormal features by simultaneously processing an RGB image and a noise residual. However, this approach utilizes a Faster Region-based Convolutional Neural Network (Faster R-CNN) architecture, and requires massive labeled data for training.

The related arts have also proposed a method of performing the image anomaly detection through end-to-end anomaly detection and a positioning network. However, the network includes an image processing module, a feature extraction module and a decision module, and has approximately 50 million parameters. Although detection performance of the network has improved, its training is costly and requires massive labeled data sets.

Moreover, deep learning-based anomaly detection methods all share the following common challenges. It is required to train a large network from scratch, massive training data is required, and model generalization capability is constrained by distribution of the training data, which makes it difficult to adapt to new anomaly types.

### 3. Auto-Encoder-Based Image Anomaly Detection

Auto-encoder, as an unsupervised learning model, is widely used in anomaly detection. Its basic principle involves training on normal data to learn data compression representation and reconstruction. After inputting abnormal data, the reconstruction error significantly increases due to deviation from training distribution.

In an image field, the related art aims to use variants such as a variational auto-encoder (VAE) and a de-noising auto-encoder (DAE) for anomaly detection. Generally, these methods use a relatively simple network architecture (with millions of parameters) trained from scratch on specific data sets. However, these small-scale auto-encoders have limited representation capabilities and struggle to capture detailed features in complex images.

In addition to the above image anomaly detection methods, the related art also proposes a latent diffusion model (LDM), which has significantly improved computing capabilities by performing a diffusion processing in a latent space rather than a pixel space. The auto-encoder with the LDM exhibit features of:

(1) having an encoder which compresses an image from the pixel space to the latent space (typically with a compression ratio of 8×8).

(2) having a decoder which reconstructs a high-quality image from a latent representation.

(3) pre-training based on large-scale high-quality image data sets.

(4) having massive model parameters, e.g., a FLUX auto-encoder has approximately 83 million parameters.

Although these auto-encoders demonstrate powerful image understanding and reconstruction capabilities, currently, they are mainly applied to image generation tasks, and their potential for image anomaly detection, particularly in detecting the tampered document images, remains largely unexplored.

As the scale of the pre-trained model continues to expand, developing efficient methods for task adaptation has become a critical research focus.

In the related arts, low-rank adaptation (LoRA) achieves efficient fine-tuning by adding a low-rank decomposition matrix alongside a pre-training weight. In detail, the LoRA adds ΔW=BA for a weight matrix W∈R^{(d×k)}, where B∈R^{(d×r)} and A∈R^{(r×k)}, a rank r is much less than min(d, k). Although this method is highly parameter-efficient, it requires modifying a forward computation process of the model.

An adapter method inserts small trainable modules between network layers to keep pre-training parameters frozen. However, this method may increase model depth and inference latency.

Tensor decomposition is a crucial model compression technique. For example, Tucker decomposition decomposes a high-order tensor into a product of a core tensor and a group of factor matrices. CANDECOMP/PARAFAC (CP) decomposition represents a tensor as a sum of rank-1 tensors. High-order singular value decomposition (HOSVD) is a special case of Tucker decomposition. While these tensor decomposition techniques are primarily used for model compression and acceleration, their application in task adaptation while preserving pre-training knowledge remains understudied.

In conclusion, in the related arts, the image anomaly detection has the following problems.

### 1. Failure to Fully Leverage Powerful Modeling Capabilities of Pre-Trained Auto-Encoders

There are limitations in recognizing the value of the pre-trained auto-encoders in related arts. On one hand, most methods still rely on small auto-encoders trained from scratch (such as a CNN-based VAE) or do not use the auto-encoders at all. This type of model is trained only on a limited data set and exhibits weak modeling capabilities for statistical image patterns (e.g., struggling to capture subtle variations in text edges). On the other hand, few methods attempt using the pre-trained auto-encoders, but fail to recognize unique advantages of auto-encoders in diffusion models (such as FLUX and Stable Diffusion). These auto-encoders in the diffusion models have been pre-trained on hundreds of millions of high-quality images, becoming “experts” in understanding the distribution of natural images, which may stably reconstruct normal images that conform to statistical patterns, while exhibiting significant reconstruction inconsistencies for anomalies deviating from the distribution, such as tampered regions.

Due to these limitations, the related arts fail to leverage the powerful modeling capabilities of the auto-encoders for the normal images and recognize that the auto-encoders in the diffusion models exhibit significant reconstruction inconsistencies for anomalies deviating from the distribution, such as tampered regions.

### 2. Waste of Pre-Trained Knowledge Due to an Absence of Non-Destructive Model Adaptation Mechanisms;

The related art commonly employs a destructive strategy when adapting the pre-trained model to an image anomaly detection task, which directly undermines a primitive capability of the model.

Firstly, a full-parameter fine-tuning method adapts to a new task by adjusting all parameters. That is, the method enhances its performance in a specific scenario at the cost of destroying image-related prior knowledge acquired during a pre-training stage, such as natural distribution patterns of text edges in images. Therefore, the model becomes a single-task specific tool that is unusable for other scenarios, such as normal image reconstruction.

Secondly, the method for training from scratch completely abandons pre-training knowledge. It requires massive labeled data (tampered files are scarce, and the acquisition cost is extremely high), and has poor model generalization capabilities due to the limited distribution of training data, rendering it nearly ineffective against new anomalies.

In conclusion, the lack of a parameter space separation protection mechanism in the related art makes it impossible to preserve the core knowledge of pre-trained models while learning the image anomaly detection capabilities. Therefore, the value of the pre-trained model is significantly undervalued.

### 3. Inability to Address High-Frequency and Local Tampering Due to Inadequate Adaptation to Unique Features of Tampered Document Images

Tampering features (high-frequency, local, and precision) of document images are in significant conflict with the universal design principles of the related art.

Firstly, insufficient sensitivity to high-frequency information. For example, the tampering of the document images often involves adding or removing strokes of a character, changing a number in a text (e.g., changing “1” to “7”), and adjusting edges (e.g., adjusting seal outlines). These examples are essentially local disturbances of high-frequency signals. However, the model in the related art (such as a CNN model for natural image designing) prioritizes capturing low-frequency semantic information, and have low sensitivity to such high-frequency details. Therefore, there is a high probability that fine tampering may go undetected.

Secondly, a detection granularity fails to meet requirements. For example, the tampering of the document images is often local (e.g., a number in a contract or a date on an ID), and requires pixel-level precise positioning. However, the related art may only provide image-level judgment on “whether it is tampered or not” or imprecise positioning (errors often exceeding 10 pixels) due to an absence of a multi-granularity fusion strategy (e.g., a combination of a pixel-level error and a block-level feature). Therefore, the related art fails to meet service requirements for accurate positioning of a tampered region.

### 4. Weak Theoretical Foundation and Lack of Interpretability in Detection Logic

A “black-box” nature of the related art severely limits its reliability. Most methods rely on empirical designs (e.g., feature engineering by manually adjusting parameters, and end-to-end black-box networks), which fail to explain “why an abnormal region can be detected”, nor establish a clear association relationship between “anomaly feature” and “model behavior”. For example, a method using legacy auto-encoders makes a judgment on tampering solely through “a reconstruction error threshold” without explaining “why there are more errors in an abnormal region”. Moreover, a deep learning-based supervised model, relying on data-driven feature learning, struggle to clarify “which intrinsic features of anomalies the model focuses on”.

The theoretical deficiency results in a lack of generalization basis for the related art when facing new scenarios (such as unknown anomaly types), making it difficult to validate a reliability of a detection result.

To address these issues, the disclosure provides an image detection method, a model training method, an apparatus and an electronic device, capable of utilizing the following reconstruction features exhibited by models which have been pre-trained based on massive real images and have learned a statistical distribution of natural images when processing images with abnormal regions: a reconstruction error in an abnormal region being significantly greater than a reconstruction error in a normal region, and realizing high-precision image anomaly detection and positioning.

For the models which have been pre-trained based on the massive real images and have learned the statistical distribution of natural images when processing the images with the abnormal regions, due to the presence of the abnormal regions in the images, local anomalies are introduced, resulting in a deviation in the distribution of the images. Therefore, when processing the images with the abnormal regions, the images exhibit the above reconstruction features.

An image detection method, a model training method, an apparatus and an electronic device according to embodiments of the disclosure are described below with reference to the accompanying drawings.

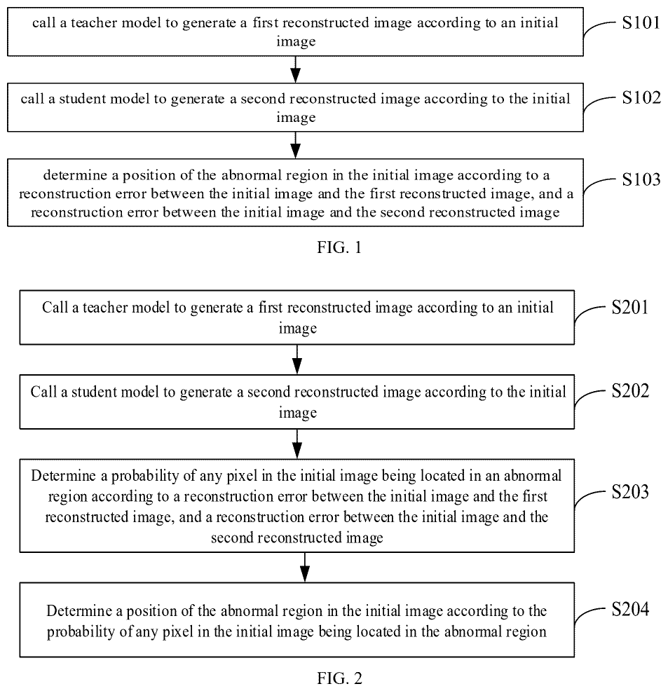

FIG. 1 is a flowchart of an image detection method provided by an embodiment of the disclosure.

As illustrated in FIG. 1, the image detection method includes the following steps.

At step S101, a teacher model is called to generate a first reconstructed image according to an initial image.

In an example, an entity for executing the image detection in the embodiment of the disclosure may be a hardware device with data processing capabilities and/or necessary software to drive the hardware device to operate. The entity may include a server, a user terminal, and other smart devices. The user terminal may include, but is not limited to, a mobile phone, a computer and a smart voice interaction device. The server may include, but is not limited to, a web server, an application server, a server within a distributed system, or a server combined with a block-chain, which is not limited in the embodiment of the disclosure.

The teacher model may be any model that has been pre-trained based on massive real images and has learned a statistical distribution of natural images.

The teacher model may be a pre-trained auto-encoder in a diffusion model, such as FLUX and Stable Diffusion.

The pre-trained auto-encoder in the diffusion model is trained based on hundreds of millions of high-quality images, becoming “experts” in understanding the distribution of natural images, which can stably reconstruct normal images conforming to statistical patterns while exhibiting significant reconstruction inconsistencies for anomalies deviating from the distribution (such as a tampered region).

As an example, a structure of the teacher model may include:
an encoder, used to compress a 512×512 RGB image into a 64×64 latent space (i.e., 8×down-sampling), to obtain a mean and a standard deviation of a latent distribution;
a sampler, used to generate a 64×64 latent representation based on the mean and the standard deviation of the latent distribution and a standard Gaussian distribution; and
a decoder, used to reconstruct an image with an initial resolution from the latent representation.

In some embodiments, the pre-trained auto-encoder in the diffusion model may be obtained and used as the teacher model.

In some embodiments, the first reconstructed image is generated based on the initial image by calling the teacher model. For example, the initial image is input to the teacher model to obtain the first reconstructed image output by the teacher model.

At step S102, a student model is called to generate a second reconstructed image according to the initial image.

The student model is a module obtained after trained based on the teacher model, and the student model has learned a capability to detect an abnormal region in an image.

The abnormal region may refer to a tampered area in the image, such as a character manually replaced by another one in a document image, and a traffic violation scenario added artificially to a traffic image (e.g., a scenario in which pedestrians crossing a rode against red lights). The abnormal region may also be a region in an image that does not conform to normal patterns or expectations, such as “motion blur” in a photo (when photographing a moving object with an excessively slow shutter speed, the object exhibits “motion blur”), and an “irregular shadow area” in a medical film (e.g., an “irregular shadow area” appearing in a lung region on an X-ray film, differing from a uniform density of healthy lungs and potentially indicating lesions).

The student model is trained based on the teacher model. After training, the student model has learned the capability to detect the abnormal region in the image. Compared to the teacher model, a reconstruction error in the abnormal region of the image generated by the student model is significantly greater than a reconstruction error in a normal region of the image during image reconstruction.

As an example, a training objective of the student model may be that for the abnormal region in the image, a reconstruction error between the reconstructed image generated by the student model and the initial image is greater than a reconstruction error between the reconstructed image generated by the teacher model and the initial image, and for the normal region in the image, the reconstruction error between the reconstructed image generated by the student model and the initial image is less than the reconstruction error between the reconstructed image generated by the teacher model and the initial image.

The teacher model has been pre-trained based on hundreds of millions of high-quality images, and possesses robust image comprehension capabilities. During a compression-reconstruction process, it amplifies anomalies in out-of-distribution data (the statistical distribution of natural images). Therefore, during the image reconstruction, the reconstruction error in the abnormal region of the image generated by the teacher model is significantly greater than the reconstruction error in the normal region of the image. After training, the student model, compared with the teacher model, has a much higher reconstruction error in the abnormal region of the image generated by the student model over the normal region of the image during the image reconstruction.

In some embodiments, parameter fine-tuning is performed based on the teacher model, and the fine-tuned model is then trained to obtain the student model. The student model obtained after training has learned the capability to detect the abnormal region in the image.

The process of obtaining the student model does not involve any change to the teacher model.

As an example, the pre-trained auto-encoder in the diffusion model is obtained and used as the teacher model. The teacher model remains completely frozen (i.e., the teacher model remains unchanged). Then, a copy of the pre-trained auto-encoder in the diffusion model (also known as the teacher model) is created. Parameters of the copied model are fine-tuned to obtain a student model to be trained. The student model to be trained is trained to obtain the student model. The student model obtained after training has acquired the capability to detect the abnormal region in the image.

In some embodiments, the second reconstructed image is generated based on the initial image by calling the student model. For example, the initial image is input into the student model to obtain the second reconstructed image output by the student model.

At step S103, a position of the abnormal region in the initial image is determined according to a reconstruction error between the initial image and the first reconstructed image and a reconstruction error between the initial image and the second reconstructed image.

The reconstruction errors between the initial image and the first reconstructed image distributed more in the abnormal region and less in the normal region. Based on this, while an approximate position of the abnormal region in the initial image may be determined, an accuracy of the identified abnormal region cannot be guaranteed. Similarly, relying solely on the reconstruction error between the initial image and the second reconstructed image to determine the abnormal region also fails to ensure the accuracy of the identified abnormal region.

In some embodiments, to ensure the accuracy of detecting the abnormal region in the image, the position of the abnormal region in the initial image is determined based on the reconstruction error between the initial image and the first reconstructed image and the reconstruction error between the initial image and the second reconstructed image.

Compared to the teacher model, the reconstruction error in the abnormal region in the image generated by the student model is significantly greater over the reconstruction error in the normal region of the image during the image reconstruction. For the abnormal region in the initial image, the reconstruction error between the initial image and the second reconstructed image is greater than the reconstruction error between the initial image and the first reconstructed image. For the normal region in the initial image, the reconstruction error between the initial image and the second reconstructed image is less than the reconstruction error between the initial image and the first reconstructed image. Based on this, the position of the abnormal region in the initial image may be accurately determined.

According to the image detection method provided in the embodiment of the disclosure, the student model is trained based on the teacher model, which allows the student model to inherit a fundamental image processing capability of the teacher model while focusing on learning how to detect the abnormal region in the image. Therefore, the student model achieves a significantly higher reconstruction accuracy for the abnormal region compared to the teacher model. Based on the errors between the initial image and the two reconstructed images, the abnormal and normal regions in the initial image can be accurately distinguished. The detection method based on error comparison does not rely on complex manually labeled features, which not only enhances the accuracy of detecting the abnormal region in the image, but also adapts to detection requirements of abnormal regions across different types of images, thereby improving user experience.

FIG. 2 is a flowchart of another image detection method provided by an embodiment of the disclosure.

As illustrated in FIG. 2, the image detection method includes the following steps.

At step S201, a teacher model is called to generate a first reconstructed image according to an initial image.

In some embodiments, before calling the teacher model to generate the first reconstructed image based on the initial image, the initial image is resized to reach a target resolution, and then normalization processing is performed on the resized initial image to normalize pixel values in the resized initial image to a target value range.

As an example, an initial image I may be resized to the resized initial image with 512×512 pixels:

$${I}_{resized} = Resize ( I , ( 512 , 512 ) ) .$$

Then, pixel values in the resized initial image I_{resized} are normalized to a range [−1,1]:

$${I}_{norm} = ( {I}_{resized} - 127 \text{.5} ) / 12 \; 7.5$$

In the embodiment of the disclosure, before calling the teacher model to generate the first reconstructed image, the initial image is resized to ensure that the initial image meets input requirements of the teacher model and to prevent reconstruction distortion due to a mismatched image resolution. By normalizing the pixel values in the resized initial image to the target range, an interference of data distribution imbalance on reconstruction accuracy may be reduced, which ensures a result with a greater accuracy and a higher reliability when subsequently determining a probability of a pixel being located in the abnormal region based on the reconstruction error.

In some embodiments, the teacher model includes a first encoder, a first sampler and a first decoder. The first encoder may be called to encode the initial image, and obtain a mean and a standard deviation of a first latent distribution of the initial image. The first latent distribution is used to indicate a distribution condition of an encoding result obtained by encoding the initial image by the first encoder. The first sampler is called to sample the mean and the standard deviation of the first latent distribution of the initial image, to obtain a first latent representation of the initial image. The first decoder is called to decode the first latent representation of the initial image to obtain the first reconstructed image.

For example, the initial image is represented as I∈R^{(H×W×3)}, where H represents a height of the initial image and W represents a width of the initial image. After resizing, the resized initial image is represented as I_{resized}∈R^{(H×W×3)}, where H represents a height of the resized initial image I_{resized} and W represents a width of the resized initial image I_{resized}, and H=W=512. After the normalization processing, the normalized initial image is represented as Iₙₒᵣₘ∈[−1, 1]^{(H×W×3)}, where H represents a height of the normalized initial image Iₙₒᵣₘ and W represents a width of the normalized initial image Iₙₒᵣₘ, and H=W=512. The normalized initial image is input into the first encoder of the teacher model for encoding, and the mean μ_{T} and the standard deviation or of the first latent distribution of the initial image are obtained:

$${μ}_{T} , {σ}_{T} = {ε}_{T} ( {I}_{norm} ) ,$$

where ε_{γ}(Iₙₒᵣₘ) represents that the first encoder encodes Iₙₒᵣₘ.

The mean μ_{T} and the standard deviation σ_{T} of the first latent distribution of the initial image are input into the first sampler of the teacher model for sampling, to obtain the first latent representation Z_{T} of the initial image, where Z_{T}∈R^{(64×64×4)}.

The first latent representation Z_{T} of the initial image is input into the first decoder of the teacher model for decoding, to obtain the first reconstructed image Î_{T}:

$${\hat{I}}_{T} = {D}_{T} ( {Z}_{T} ) ,$$

where D_{T}(Z_{T}) represents that the first decoder decodes Z_{T}, and Î_{T}∈R^{(H×W×3)}, H represents a height of the first reconstructed image ÎT and W represents a width of the first reconstructed image Î_{T}, and H=W=512.

In the embodiment of the disclosure, the first encoder encodes the initial image to deeply mine essential features of the initial image, and obtain the mean and the standard deviation of the first latent distribution. The first latent distribution clearly indicates a distribution pattern of the encoding result of the first encoder, thereby avoiding information loss or redundancy during feature extraction. The first sampler samples the mean and the standard deviation of the first latent distribution, and introduces reasonable randomness while preserving core features, so as to reduce reconstruction limitations caused by excessive feature certainty and make the first latent representation better align with a true feature distribution of the image. The first decoder decodes the first latent representation, and fully leverages precise and representative latent features to efficiently restore details of the initial image, thereby reducing distortion during the reconstruction process.

In some embodiments, the first sampler is called to adjust a first sampling noise according to the standard deviation of the first latent distribution of the initial image and a first adjustment coefficient, to obtain a second sampling noise. The first adjustment coefficient indicates a degree of influence of the second sampling noise on the first latent representation of the initial image. The first sampler is called to determine the first latent representation of the initial image according to the second sampling noise and the mean of the first latent distribution of the initial image.

The first sampling noise may be any random noise, such as a noise with a standard Gaussian distribution.

As an example, the mean of the first latent distribution of the initial image is represented as μ_{T}, the standard deviation of the first latent distribution of the initial image is represented as σ_{T}, the first adjustment coefficient is represented as τ_{T}, and the first sampling noise is represented as ε_{T}. Since ε_{T}˜N(0,1) is a random noise sampled from a standard normal distribution N(0,1), the second sampling noise is represented as τ_{T}×σ_{T}×ε_{T}, and the first latent representation is represented as Z_{T}=μ_{T}+τ_{T}×σ_{T}×ε_{T}.

Randomness is introduced into the noise ε_{T}, to ensure that each sampled Z_{T} is not totally identical, thereby increasing output diversity. The first adjustment coefficient τ_{T} may be used to “amplify or attenuate” the influence of the noise.

The larger τ_{T} is, the higher a weight of the noise, resulting in stronger randomness and greater diversity in outputs. However, this may deviate from the goal of “accurate reconstruction” or “high-quality generation”, and lead to more reconstruction errors in the teacher model.

The smaller σ_{T} is, the lower the weight of the noise, making the output closer to the mean μ_{T} of the first latent distribution. This results in increased certainty and reduced diversity, but may yield a higher accuracy in reconstruction/generation.

During the training process of the student model, the teacher model may perform a sampling processing using the first adjustment coefficient τ_{T}=1.5˜3.0, to enhance the diversity of reconstruction of the teacher model, which enables the student model to learn more robust features. When generating the reconstructed image in practice, τ_{T} is adjusted according to a generation objective to achieve trade-off of diversity and quality. For example, a more stable reconstruction result is obtained by reducing τ_{T}, while a more varied generation result is obtained by increasing τ_{T}.

In the embodiment of the disclosure, the first adjustment coefficient precisely indicates the degree of influence of the second sampling noise on the first latent representation. It enables flexible control over the noise intensity based on varying requirements for latent representation accuracy and stability in practical application scenarios, thereby avoiding potential issues of excessive or insufficient noise interference that may arise under fixed noise patterns. By leveraging two key statistical features, namely, the standard deviation and the mean, of the first latent distribution of the initial image for noise adjustment and latent representation computation, the second sampling noise may better align with an intrinsic distribution pattern of data of the initial image. This ensures that the final first latent representation more closely matches true features of the initial image, thereby enhancing the accuracy and reliability of the latent representation.

At step S202, a student model is called to generate a second reconstructed image according to the initial image.

The student model is a module obtained after trained based on the teacher model, and the student model has learned a capability to detect an abnormal region in an image.

In some embodiments, the student model includes a second encoder, a second sampler and a second decoder. The second encoder is called to encode the initial image, to obtain a mean and a standard deviation of a second latent distribution of the initial image. The second latent distribution indicates a distribution condition of an encoding result obtained by encoding the initial image by the second encoder. The second sampler is called to sample the mean and the standard deviation of the second latent distribution of the initial image, to obtain a second latent representation of the initial image. The second decoder is called to decode the second latent representation of the initial image, to obtain the second reconstructed image.

For example, the initial image is represented as I∈R^{(H×W×3)}, where H represents a height of the initial image and W represents a width of the initial image. After resizing, the resized initial image is represented as I_{resized}∈R^{(H×W×3)}, where H represents a height of the resized initial image I_{resized} and W represents a width of the resized initial image I_{resized}, and H=W=512. After the normalization processing, the normalized initial image is represented as Iₙₒᵣₘ∈[−1,1]^{(H×W×3)}, where H represents a height of the normalized initial image Iₙₒᵣₘ and W represents a width of the normalized initial image Iₙₒᵣₘ, and H=W=512. The normalized initial image is input into the second encoder of the student model for encoding, and the mean μ_{S} and the standard deviation σ_{S} of the second latent distribution of the initial image are obtained:

$${μ}_{S} , {σ}_{S} = {ε}_{S} ( {I}_{norm} ) ,$$

where ε_{S}(Iₙₒᵣₘ) represents that the second encoder encodes Iₙₒᵣₘ.

The mean μ_{S} and the standard deviation σ_{S} of the second latent distribution of the initial image are input into the second sampler of the student model for sampling, to obtain the second latent representation Z_{S} of the initial image, where Z_{S}∈R^{(64×64×4)}.

The second latent representation Z_{S} of the initial image is input into the second decoder of the student model for decoding, to obtain the second reconstructed image Î_{S}:

$${\hat{I}}_{S} = {D}_{S} ( {Z}_{S} ) ,$$

where D_{S}(Z_{S}) represents that the second decoder decodes Z_{S}, and Î_{S}∈R^{(H×W×3)}, H represents a height of the second reconstructed image Is and W represents a width of the second reconstructed image Î_{S}, and H=W=512.

In the embodiment of the disclosure, the second encoder encodes the initial image to deeply mine the essential features of the initial image, and obtain the mean and the standard deviation of the second latent distribution. The second latent distribution clearly indicates the distribution pattern of the encoding result of the second encoder, thereby avoiding information loss or redundancy during feature extraction. The second sampler samples the mean and the standard deviation of the second latent distribution, and introduces reasonable randomness while preserving core features, so as to reduce reconstruction limitations caused by excessive feature certainty and make the second latent representation better align with the true feature distribution of the image. The second decoder decodes the second latent representation, and fully leverages precise and representative latent features to efficiently restore details of the initial image, thereby reducing distortion during the reconstruction process.

In some embodiments, the second sampler is called to adjust a third sampling noise according to the standard deviation of the second latent distribution of the initial image and a second adjustment coefficient, to obtain a fourth sampling noise. The second adjustment coefficient indicates a degree of influence of the fourth sampling noise on the second latent representation. The second latent representation of the initial image is determined according to the fourth sampling noise and the mean of the second latent distribution of the initial image.

The third sampling noise may be any random noise, such as a noise with a standard Gaussian distribution.

As an example, the mean of the second latent distribution of the initial image is represented as μ_{S}, the standard deviation of the second latent distribution of the initial image is represented as σ_{S}, the second adjustment coefficient is represented as τ_{S}, and the third sampling noise is represented as ε_{S}. Since ε_{S}˜N(0,1) is a random noise sampled from a standard normal distribution N(0,1), the fourth sampling noise is represented as τ_{S}×σ_{S}×ε_{S}, and the second latent representation is represented as Z_{S}=μ_{S}+τ_{S}×σ_{S}×ε_{S}.

Randomness is introduced into the noise ε_{S}, to ensure that each sampled Z_{S} is not totally identical, thereby increasing output diversity.

The second adjustment coefficient τ_{S} of the student model=1.

In the embodiment of the disclosure, the second adjustment coefficient precisely indicates the degree of influence of the fourth sampling noise on the second latent representation. It enables flexible control over the noise intensity based on varying requirements for latent representation accuracy and stability in practical application scenarios, thereby avoiding potential issues of excessive or insufficient noise interference that may arise under fixed noise patterns. By leveraging two key statistical features, namely, the standard deviation and the mean, of the second latent distribution of the initial image for noise adjustment and latent representation computation, the fourth sampling noise may better align with the intrinsic distribution pattern of the data of the initial image. This ensures that the final second latent representation more closely matches the true features of the initial image, thereby enhancing the accuracy and reliability of the latent representation.

For additional descriptions for steps S201-S202, reference may be made to the relevant descriptions of any embodiment of the disclosure, and details may not be repeated here.

At step S203, a probability of any pixel in the initial image being located in an abnormal region is determined according to a reconstruction error between the initial image and the first reconstructed image and a reconstruction error between the initial image and the second reconstructed image.

In some embodiments, a reconstruction error between a first pixel and a second pixel is determined according to the first pixel in the initial image corresponding to a first position and the second pixel in the first reconstructed image corresponding to the first position. A reconstruction error between the first pixel and a third pixel is determined according to the first pixel and the third pixel in the second reconstructed image corresponding to the first position. The probability of the first pixel being located in the abnormal region is determined according to the reconstruction error between the first pixel and the second pixel and the reconstruction error between the first pixel and the third pixel.

The reconstruction error between the first pixel and the second pixel and the reconstruction error between the first pixel and the third pixel may be determined with a L1 distance (i.e., 1-norm, which is also known as a Manhattan distance). Or, the reconstruction error between the first pixel and the second pixel and the reconstruction error between the first pixel and the third pixel may be determined with a L2 distance (i.e., 2-norm, which is also known as a Euclidean distance). Or, the reconstruction error between the first pixel and the second pixel and the reconstruction error between the first pixel and the third pixel may be determined using other distance calculation methods, which is not limited herein and may be set according to practical requirements.

As an example, if the first pixel in the initial image corresponding to a position (i, j) is represented as Iₙₒᵣₘ[i, j], and the second pixel in the first reconstructed image corresponding to the position (i, j) is represented as Î_{T}[i, j], the reconstruction error ε_{T}[i, j] between the first pixel and the second pixel is calculated by the following equation:

$${ε}_{T} [ i , j ] = {‖ {I}_{norm} [ i , j ] - {\hat{I}}_{T} [ i , j ] ‖}_{1} .$$

If a third pixel in the second reconstructed image corresponding to the position (i, j) is represented as Î_{S}[i, j], the reconstruction error as ε_{S}[i, j] between the first pixel and the third pixel is calculated by the following equation:

$${ε}_{S} [ i , j ] = {‖ {I}_{norm} [ i , j ] - {\hat{I}}_{S} [ i , j ] ‖}_{1} .$$

In the embodiment of the disclosure, the reconstruction errors between the first pixel in the initial image and the second pixel and the third pixel at the corresponding position in the first reconstructed image and the second reconstructed image are calculated respectively. Based on the reconstruction error results of these two calculation processes, the probability of the first pixel being located in the abnormal region is determined comprehensively. By introducing a comparison dimension between two different reconstructed images, it effectively avoids misjudgments caused by model bias or noise interference in a single reconstructed image, thereby enhancing the reliability of the judgment of the abnormal region.

In some embodiments, a reconstruction error difference of the first pixel is determined according to the reconstruction error between the first pixel and the second pixel and the reconstruction error between the first pixel and the third pixel. The probability of the first pixel being located in the abnormal region is obtained by performing the normalization processing on the reconstruction error difference of the first pixel.

Compared to the teacher model, the reconstruction error in the abnormal region of the image generated by the student model is significantly greater over the reconstruction error in the normal region of the image during the image reconstruction. If the first pixel is located in the abnormal region, the reconstruction error between the first pixel and the second pixel is greater than the reconstruction error between the first pixel and the third pixel. If the first pixel is not in the abnormal region, the reconstruction error between the first pixel and the second pixel is less than the reconstruction error between the first pixel and the third pixel.

The reconstruction error difference of the first pixel may be obtained by calculating the difference. That is, the difference between the reconstruction error between the first pixel and the second pixel and the reconstruction error between the first pixel and the third pixel is taken as the reconstruction error difference of the first pixel.

For example, if the reconstruction error between the first pixel and the second pixel is represented as ε_{T}[i,j], and the reconstruction error between the first pixel and the third pixel is represented as ε_{S}[i,j], the reconstruction error difference of the first pixel is represented by ε_{S}[i,j]-ε_{T}[i,j].

The reconstruction error difference of the first pixel is normalized to the target range through the normalization processing.

In the embodiment of the disclosure, determining the reconstruction error difference of any pixel in the initial image may effectively amplify the difference between the pixel located in the abnormal region and the pixel in the normal region in the initial image. Through normalization processing, it may eliminate scale differences among various reconstruction errors, and generate a uniform and comparable criteria for judgment.

In some embodiments, the reconstruction error difference of the first pixel is scaled according to a scale coefficient to obtain a scaled reconstruction error difference, in which the scale coefficient indicates a degree of scaling during the scaling processing. The scaled reconstruction error difference is normalized using a normalization function, to obtain the probability of the first pixel being located in the abnormal region.

A ratio of the reconstruction error difference of the first pixel to the scale component may be taken as the scaled reconstruction error difference. For example, if the reconstruction error difference of the first pixel is represented as ε_{S}[i,j]-ε_{T}[i,j] and the scale coefficient is represented as τ, the scaled reconstruction error difference is represented as (ε_{S}[i,j]-ε_{T}[i,j])/τ.

The normalization function may be a sigmoid function used to normalize the scaled reconstruction error difference to a range of [0, −1], or a tanh function used to normalize the scaled reconstruction error difference to a range of [−1, 1], or other normalization functions, which is not limited herein and may be set according to actual requirements.

As an example, if the scaled reconstruction error difference is represented as (ε_{S}[i,j]-ε_{T}[i,j])/τ and the normalization function is the sigmoid function, the probability P[i,j] of the first pixel being located in the abnormal region is calculated by the following equation:

$$P [ i , j ] = σ ( ( {ε}_{S} [ i , j ] - {ε}_{T} [ i , j ] ) / τ ) ,$$

where σ(x) represents the sigmoid function,

$$σ ( x ) = \frac{1}{1 + exp ( - x )} ,$$

and τ=0.1.

A curve of the sigmoid function

$$σ ( x ) = \frac{1}{1 + exp ( - x )}$$

may change as scaling of the input x, and (ε_{S}[i,j]-ε_{T}[i,j])/τ is equivalent to scaling the input of the sigmoid function.

The smaller τ is, the larger the value of (ε_{S}[i,j]-ε_{T}[i,j])/τ becomes. This leads to more drastic changes to the input of the sigmoid function, resulting in a steeper curve. At this point, even minor changes to the input cause the output P[i,j] to rapidly switch between “close to 0” and “close to 1”. This heightens sensitivity to changes of the reconstruction error difference, bringing about significant distinctions between abnormal and normal regions.

The larger t is, the smaller the value of (ε_{S}[i,j]-ε_{T}[i,j])/τ becomes. This leads to more gradual changes to the input of the sigmoid function, resulting in a flatter curve. At this point, the impact of changes to the input on the output P[i,j] becomes more moderate, and P[i,j] tends to cluster more in an intermediate region between 0 and 1, and its sensitivity to changes of the reconstruction error difference also decreases.

In the embodiment of the disclosure, the introduction of an adjustable scale coefficient enables flexible control over the amplification or reduction of the reconstruction error difference based on actual requirements. This makes image features in the abnormal region more prominent or smoother, thereby enhancing adaptability across different scenarios. The scaled reconstruction error difference is then normalized using the normalization function, which not only eliminates the influence of dimension, but also maps the result to a unified value range, facilitating in setting a uniform threshold for judgment. This scaling-normalization process preserves distinguishing information of an initial reconstruction error difference while enhancing sensitivity to minor abnormalities, enabling precise positioning of the abnormal region.

At step S204, a position of the abnormal region in the initial image is determined according to the probability of any pixel in the initial image being located in the abnormal region.

In some embodiments, it is determined that the any pixel in the initial image is located in the abnormal region in response to the probability of the any pixel in the initial image being located in the abnormal region satisfying a first preset probability condition. The position of the abnormal region in the initial image is determined according to a position of the any pixel located in the abnormal region in the initial image.

The first preset probability condition is a preset condition that a pixel being located in the abnormal region is satisfied. For example, the first preset probability condition may be a set threshold. When the probability of any pixel in the initial image being located in the abnormal region exceeds the set threshold, it is determined that the pixel is located in the abnormal region.

In the embodiment of the disclosure, the first preset probability condition is taken as the criterion for determining whether a pixel is located in the abnormal region, it is possible to precisely determine which pixel in the initial image is located in the abnormal region, which avoids the issues of detail omission or misjudgment that may arise from coarse assessment for the entire region. Then, the abnormal region is determined based on the positions of pixels within the abnormal region, and scattered abnormal pixels are connected into a complete and continuous abnormal region, which not only clearly reveals a specific position, size and shape of the abnormal region in the initial image, but also prevents misjudgments of individual pixels from interfering with the judgment on the entire abnormal region.

As another example, an abnormal region masked image is generated according to a difference between the probability of the any pixel in the initial image being located in the abnormal region and a second preset probability condition, in which the abnormal region masked image is used to indicate whether the any pixel in the initial image is located in the abnormal region. The position of the abnormal region in the initial image is determined according to the abnormal region masked image.

The second preset probability condition is a preset condition that a pixel being located in the abnormal region is satisfied. For example, the second preset probability condition may be a preset threshold. When a value of the probability of the any pixel in the initial image being located in the abnormal region exceeds the preset threshold, it is determined that the any pixel is located in the abnormal region.

As an example, if the second preset probability condition is the preset threshold θ, the abnormal region masked image is obtained based on the threshold:

$$M [ i , j ] = \{ \begin{matrix}1 , & if P [ i , j ] > θ \\ 0 , & else\end{matrix}$$

where P[i,j] represents the probability of the pixel in the initial image corresponding to the position (i, j) being located in the abnormal region. When P[i,j]>θ, M[i,j]=1, it indicates that the pixel in the initial image corresponding to the position (i, j) is located in the abnormal region. Otherwise, M[i,j]=0, it indicates that the pixel in the initial image corresponding to the position (i, j is not in the abnormal region.

For example, θ=0.5.

The abnormal region masked image may be M∈[0,1]^{(H×W)}, where H represents a height of the initial image and W represents a width of the initial image. The value of M is either 1 (indicating that the pixel at the corresponding position in the initial image is located in the abnormal region) or 0 (indicating that the pixel at the corresponding position in the initial image is not in the abnormal region). The position of the abnormal region in the initial image may be determined according to M.

In the embodiment of the disclosure, with generating the abnormal region masked image, whether the any pixel in the initial image is located in the abnormal region may be converted into an intuitive “yes/no” (or a different grayscale/color) mask identifier, to determine the position of the abnormal region based on the abnormal region masked image, enabling rapid identification of the entire scope of the abnormal region directly through a set of abnormal pixels with the uniform identifier in M.

In some embodiments, a probability distribution map of the abnormal region in the initial image may be generated according to the probability of the any pixel in the initial image being located in the abnormal region. The probability distribution map of the abnormal region visually presents the probability of each pixel in the initial image being located in the abnormal region as continuous values or gradient visual forms (e.g., varying shades of color).

As an example, if P[i,j] represents the probability of the pixel in the initial image corresponding to the position (i,j) being located in the abnormal region, where P[i,j]=σ((ε_{S}[i,j]-ε_{T}[i,j])/τ)), then the probability distribution map of the abnormal region is P∈[0,1]^{(H×W)}, where H represents the height of the initial image and W represents the width of the initial image.

According to the image detection method provided by the embodiment of the disclosure, the probability of each pixel in the initial image being located in the abnormal region is determined by comparing the reconstruction errors between the initial image and the first and second reconstructed images. This approach fully leverages the distinguishing information of different reconstruction methods, and effectively enhances the sensitivity to image features of the abnormal region. It also reduces the risk of misjudgment that may exist in the abnormal judgment of a single reconstruction error, and improves the accuracy of determining the possibility of the abnormal pixel. Therefore, the position of the final abnormal region aligns more closely with the actual abnormal region, and positioning error is reduced. The related arts either only output image-level judgments on “whether it is tampered with or not” or suffer from poor positioning accuracy due to a lack of a multi-granularity fusion strategy. However, the image detection method provided by the embodiment of the disclosure achieves pixel-level precise positioning by accurately determining the probability of each pixel in the initial image being located in the abnormal region, which significantly improves user experience during image detection.

FIG. 3 is a schematic diagram of a principle of an image detection method provided by an embodiment of the disclosure.

As illustrated in FIG. 3, the image detection method includes the following steps.

1. An initial image is input and preprocessing is performed on the initial image, which includes the followings.

1.1. The initial image I is resized to a resized initial image with 512×512 pixels:

$${I}_{resized} = Resize ( I , ( 512 , 512 ) ) ,$$

where I∈R^{(H×W×3)}, where H represents a height of the initial image and W represents a width of the initial image, and values of H and W are not fixed. Moreover, I_{resized}∈R^{(H×W×3)}, where H represents a height of the resized initial image I_{resized} and W represents a width of the resized initial image I_{resized}, and H=W=512.

1.2. Pixel values in the resized initial image I_{resized} are normalized to a range [−1,1]:

$${I}_{norm} = ( {I}_{resized} - 127.5 ) / 127.5 ,$$

where Iₙₒᵣₘ∈[−1,1]^{(H×W×3)}, where H represents a height of the normalized initial image Iₙₒᵣₘ and W represents a width of the normalized initial image norm, and H=W=512.

Then, the normalized initial image Iₙₒᵣₘ is input into a teacher model, which includes the followings.

(1) The normalized initial image Iₙₒᵣₘ is input into a first encoder of the teacher model for encoding, to obtain a mean μ_{T} and a standard deviation σ_{T} of a first latent distribution of the initial image:

$${μ}_{T} , {σ}_{T} = {ε}_{T} ( {I}_{norm} ) ,$$

where ε_{T}(Iₙₒᵣₘ) represents that the first encoder encodes Iₙₒᵣₘ.

(2) The mean μ_{T} and the standard deviation or of the first latent distribution are input into the first sampler for sampling, to obtain a first latent representation Z_{T} of the initial image output by the first sampler:

$${Z}_{T} = {μ}_{T} + {τ}_{T} \times {σ}_{T} \times {ε}_{T} ,$$

where Z_{T}∈R^{(64×64×4)}, and ε_{T} represents a first sampling noise. Since ε_{T}˜N(0,1) is a random noise sampled from a standard normal distribution N(0,1), τ_{T} represents a first adjustment coefficient additionally added, the larger τ_{T} is, the greater a reconstruction error of the teacher model.

The first sampler adjusts the first sampling noise ε_{T} based on the standard deviation σ_{T} and the first adjustment coefficient τ_{T} of the first latent distribution, to obtain a second sampling noise, τ_{T}×σ_{T}×ε_{T}. Then, the first latent representation Zr is obtained based on the second sampling noise, τ_{T}×σ_{T}×ε_{T}. and the mean μ_{T} of the first latent distribution.

(3) The first latent representation Z_{T} is input into a first decoder of the teacher model for decoding, to obtain the first reconstructed image Î_{T} output by the first encoder:

$${\hat{I}}_{T} = {D}_{T} ( {Z}_{T} ) ,$$

where D_{T}(Z_{T}) represents that the first decoder decodes Z_{T}, and Î_{T}∈R^{(H×W×3)}, H represents a height of the first reconstructed image Î_{T} and W represents a width of the first reconstructed image Î_{T}, and H=W=512.

Then, the normalized initial image Iₙₒᵣₘ is input into a student model (the student model is trained based on the teacher model and has a capability to detect an abnormal region in an image, i.e., compared to the teacher model, a reconstruction error in the abnormal region of the image generated by the student model is significantly greater than a reconstruction error in a normal region of the image during image reconstruction). This process includes the following steps.

Firstly, the normalized initial image Iₙₒᵣₘ is input into a second encoder of the student model for encoding, to obtain a mean μ_{S} and a standard deviation σ_{S} of a second latent distribution of the initial image:

$${μ}_{S} , {σ}_{S} = {ε}_{S} ( {I}_{norm} ) ,$$

where ε_{S}(Iₙₒᵣₘ) represents that the second encoder encodes Iₙₒᵣₘ.

Secondly, the mean μ_{S} and the standard deviation σ_{S} of the second latent distribution are input into a second sampler of the student model for sampling, to obtain a second latent representation Z_{S} of the initial image output by the second sampler:

$${Z}_{S} = {μ}_{S} + {τ}_{S} \times {σ}_{S} \times {ε}_{S} ,$$

where Z_{S}∈R^{(64×64×4)}, and as is a third sampling noise. Since ε_{S}˜N(0,1) is a random noise sampled from a standard normal distribution N(0,1), τ_{S} is a second adjustment coefficient additionally added, τ_{S}=1.

The second sampler may adjust the third sampling noise ε_{S} according to the mean μ_{S} and the standard deviation σ_{S} of the second latent distribution, to obtain a fourth sampling noise: τ_{S}×σ_{S}×ε_{S}. Then, the second latent representation Z_{S} is obtained according to the fourth sampling noise: τ_{S}×σ_{S}×ε_{S} and the mean μ_{S} of the second latent distribution.

Thirdly, the second latent representation Z_{S} is input into a second decoder of the student model for decoding, to obtain the second reconstructed image Î_{S}:

$${I}_{S} = {D}_{S} ( {Z}_{S} ) ,$$

where D_{S}(Z_{S}) represents that the second decoder decodes Z_{S}, and Î_{S}∈R^{(H×W×3)}, H represents a height of the second reconstructed image Î_{S} and W represents a width of the second reconstructed image Î_{S}, and H=W=512.

Error analysis is performed on the normalized initial image Iₙₒᵣₘ, the first reconstructed image Î_{T}, and the second reconstructed image Î_{S}. The process includes the followings.

If a pixel at a position (i, j) in the Iₙₒᵣₘ is represented by Iₙₒᵣₘ[i, j], and a pixel at the position (i, j) in the Î_{T} is represented by Î_{T}[i, j], a reconstruction error ε_{T}[i, j] between the Iₙₒᵣₘ[i, j] and the Î_{T} [i, j] is calculated by the following equation:

$${ε}_{T} [ i , j ] = {‖ {I}_{norm} [ i , j ] - {\hat{I}}_{T} [ i , j ] ‖}_{1} .$$

Similarly, if a pixel at the position (i, j) in the Î_{S} is represented by Î_{S}[i, j], a reconstruction error ε_{S}[i, j] between the Iₙₒᵣₘ[i, j] and the Î_{S}[i, j] is calculated by the following equation:

$${ε}_{S} [ i , j ] = {‖ {I}_{norm} [ i , j ] - {\hat{I}}_{S} [ i , j ] ‖}_{1} .$$

The probability P[i,j] of the Iₙₒᵣₘ[i, j] being located in the abnormal region is calculated according to the reconstruction error ε_{T}[i, j] between the Iₙₒᵣₘ[i, j] and the Î_{T}[i, j] and the reconstruction error ε_{S}[i, j] between the Iₙₒᵣₘ[i, j] and the Î_{S}[i, j] by the following equation:

$$P [ i , j ] = σ ( ( {ε}_{S} [ i , j ] - {ε}_{T} [ i , j ] ) / τ ) ,$$

where σ(x) represents a sigmoid function,

$$σ ( x ) = \frac{1}{1 + exp ( - x )} ,$$

and τ=0.1.

The probability distribution map of the abnormal region, P∈[0,1]^{(H×W)}. is obtained, where H represents the height of the normalized initial image Iₙₒᵣₘ and W represents its width, and H=W=512. The abnormal region masked image M∈[0,1]^{(H×W)} is obtained based on a threshold, where H represents the height of the normalized initial image Iₙₒᵣₘ and W represents its width, and H=W=512:

$$M [ i , j ] = \{ \begin{matrix}1 , & if P [ i , j ] > θ \\ 0 , & else\end{matrix} ,$$

where θ represents a preset condition that a pixel being located in the abnormal region is satisfied, θ=0.5. When P[i,j]>θ, M[i,j]=1, it indicates that Iₙₒᵣₘ[i,j] is located in the abnormal region. Otherwise, M[i,j]=0, it indicates that Iₙₒᵣₘ[i,j] is not in the abnormal region.

Thus, based on the abnormal region masked image M∈[0,1]^{(H×W)}, it is determined which pixel in the Iₙₒᵣₘ is located in the abnormal region, and then the position of the abnormal region in the Iₙₒᵣₘ may be further determined.

The image detection method provided by the disclosure may be used to detect tampered document images. The teacher model uses a pre-trained auto-encoder in a diffusion model.

The choice of the pre-trained auto-encoder in the diffusion model stems from its robust image comprehension capabilities and sensitivity to details, particularly high-frequency information, based on pre-training on hundreds of millions of high-quality images, which makes it well-suited for detecting the tampered region in the document image. Furthermore, its compression-reconstruction process amplifies anomalies in out-of-distribution data, such as data in a tampered region.

The tampered document image generally involves tampered texts or numbers, and these changes are manifested as alterations in high-frequency edge information at the pixel level. For example, examples of tampering involve changing a number “1000” to “10000,” changing a date, or replacing a seal. The tampered region often occupies only a small portion of the image but includes massive high-frequency details. In the related arts, the detection method based on natural images exhibit insufficient sensitivity to such subtle high-frequency changes.

In practical applications, it is not only necessary to determine whether a document image has been tampered with, but also to accurately label specific tampered positions. For example, when reviewing a contract, a tampered figure needs to be precisely circled. During credentials verification, a tampered photograph or text needs to be clearly marked.

The image detection method provided in the disclosure determines which pixel in the image is located in the abnormal region, and then accurately determines the tampered region in the document image.

A document reviewing system generally handles a large amount of documents, which demands a high processing speed. Moreover, the detection model may need to be deployed across diverse hardware environments.

The student model and the teacher model being called in the image detection method provided by the disclosure may be deployed in any hardware environment for image anomaly detection. They may control computation overhead and storage requirements while ensuring detection accuracy.

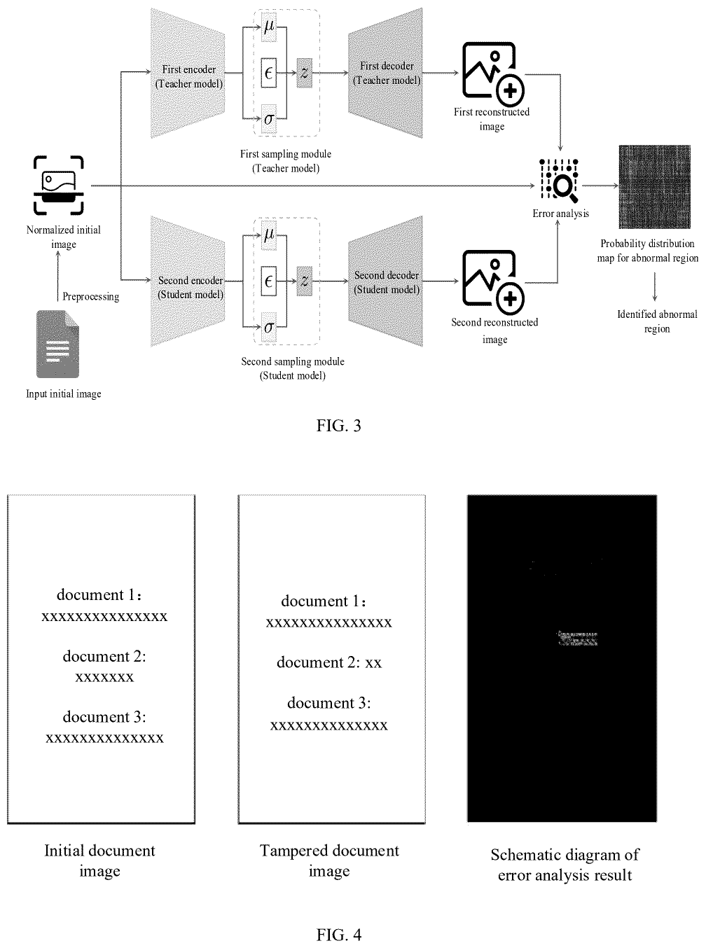

As an example, if the initial document image and the tampered document image are as shown in FIG. 4, and the teacher model has learned image distribution features of the initial document image by pre-training on massive similar document images, the tampered document image is input into both the teacher model and the student model, and error analysis is performed on the first reconstructed image generated by the teacher model, the second reconstructed image generated by the student model and the initial document image, to obtain the schematic diagram of the error analysis result as shown in FIG. 4, and the schematic diagram of the error analysis result accurately determines the position of the abnormal region.

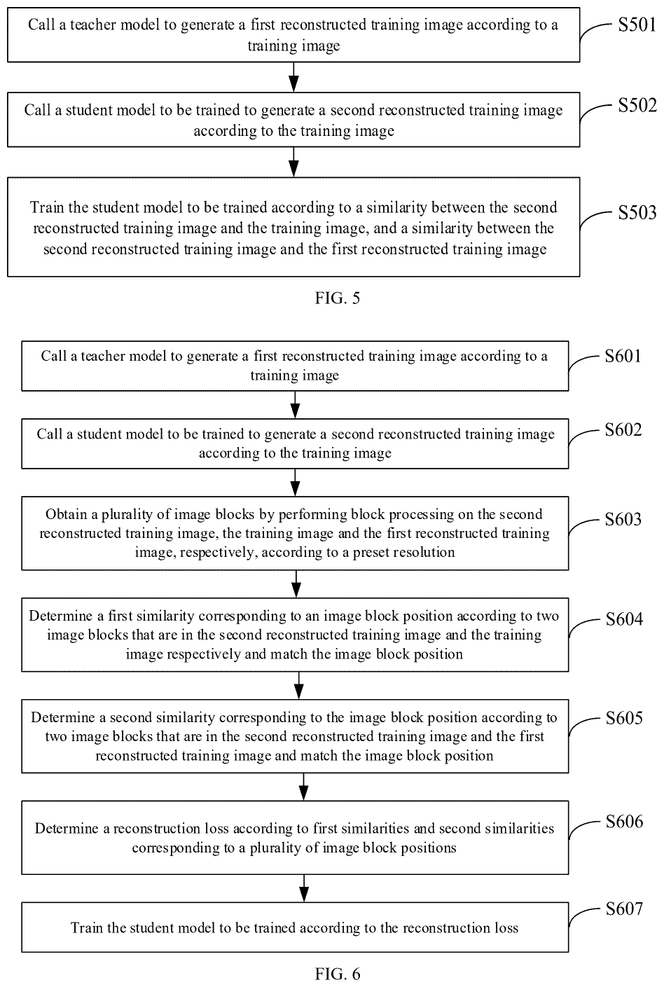

FIG. 5 is a flowchart of a model training method provided by an embodiment of the disclosure.

As illustrated in FIG. 5, the model training method includes the following steps.

At step S501, a teacher model is called to generate a first reconstructed training image according to a training image.

For the description of the teacher model, reference may be made to the relevant description in any embodiment of the disclosure, and details may not be repeated here.

The training image may be any image with an abnormal region.

In some embodiments, the abnormal region in the training image is labeled for the student model to learn how to identify image features of the abnormal region.

In some embodiments, the first reconstructed training image is generated according to the training image by calling the teacher model. For example, the training image is input into the teacher model to obtain the first reconstructed training image output by the teacher model.

At step S502, a student model to be trained is called to generate a second reconstructed training image according to the training image.

The student model to be trained is determined based on the teacher model.

For, the description of the student model, reference may be made to the relevant description in any embodiment of the disclosure, and details may not be repeated here.

In some embodiments, the second reconstructed training image is generated according to the training image by calling the student model to be trained. For example, the training image is input into the student model to be trained to obtain the second reconstructed training image output by the student model to be trained.

At step S503, the student model to be trained is trained according to a similarity between the second reconstructed training image and the training image and a similarity between the second reconstructed training image and the first reconstructed training image.

In some embodiments, the training image is labeled with the abnormal region. Based on similarities between the second reconstructed training image and the training image in the abnormal region and the normal region, and similarities between the second reconstructed training image and the first reconstructed training image in the abnormal region and the normal region, targeted training is performed on the student model to be trained, to enable the student model obtained after training to acquire a capability of detecting the abnormal region in the image. That is, compared to the teacher model, a reconstruction error in the abnormal region of the image generated by the student model is significantly greater than a reconstruction error in the normal region of the image during image reconstruction.

As an example, a training objective of the student model may be that for the abnormal region in the image, a reconstruction error between the reconstructed image generated by the student model and the initial image is greater than a reconstruction error between the reconstructed image generated by the teacher model and the initial image, and for the normal region in the image, the reconstruction error between the reconstructed image generated by the student model and the initial image is less than the reconstruction error between the reconstructed image generated by the teacher model and the initial image.

According to the model training method provided in the embodiment of the disclosure, the teacher model is introduced as a reference, and the student model to be trained is enabled to not only ensure a reconstruction accuracy with the training image as a target but also leverage the high-quality features and reconstruction logic of the teacher model through the first reconstructed training image, which effectively reduces an exploration cost when the student model learns independently, accelerates a model convergence speed, and shortens an overall training period.

FIG. 6 is a schematic diagram of another model training method provided by an embodiment of the disclosure.

As illustrated in FIG. 6, the model training method includes the following steps.

At step S601, a teacher model is called to generate a first reconstructed training image according to a training image.

At step S602, a student model to be trained is called to generate a second reconstructed training image according to the training image.

The student model to be trained is determined based on the teacher model.

For the descriptions of steps S601-S602, reference may be made to the relevant description in any embodiment of the disclosure, and details may not be repeated here.

At step S603, a plurality of image blocks are obtained by performing block processing on the second reconstructed training image, the training image and the first reconstructed training, respectively, according to a preset resolution.

The preset resolution may be any preset resolution, such as 8×8 pixels.

As an example, if the resolution of the training image is 512×512 pixels, the resolutions of both the first reconstructed training image generated by the teacher model and the second reconstructed training image generated by the student model to be trained are 512×512 pixels (for the principle, reference may be made to the relevant description in any embodiment of the disclosure, and details may not be repeated here), and a 512×512 image may be divided into 64×64 blocks.

At step S604, a first similarity corresponding to an image block position is determined according to two image blocks that are in the second reconstructed training image and the training image respectively and match the image block position.

In a case where the size of the second reconstructed training image is the same as the size of the training image, position matching may be applied for two image blocks at the same position in both the second reconstructed training image and the training image. These two image blocks are allowed to extend outward by a certain number of pixels according to a specific rule. In a case where the size of the second reconstructed training image is different from the size of the training image, the position matching may be applied for two corresponding image blocks in both the second reconstructed training image and the training image, that is, a correspondence between an image block in the second reconstructed training image and an image block in the training image is determined according to a position of each image block within the entire image of the second reconstructed training image and a position of each image block within the entire image of the training image.

As an example, the first similarity corresponding to the image block position is determined by the following equation:

$${sim}_{image} [ m , n ] = 1 - 0.5 \times mean ( \vert {I}^{( {ℬ}_{m , n} )} - {\hat{I}}_{S}^{( {ℬ}_{m , n} )} \vert )$$

where I^{(Bm,n)} represents an image block at a position (m, n) in the taming image I,

$${\hat{I}}_{S}^{( Bm , n )}$$

represents an image block at the position (m, n) in the second reconstructed training image Î_{S}, and sim_{image}[m, n] represents a first similarity corresponding to the image block position (m, n).

The meaning of the above equation may include:
calculating an absolute value of a pixel difference between I^{(Bm,n)} and Î_{S}^{(Bm,n)} through

$$\vert {I}^{( Bm , n )} - {\hat{I}}_{S}^{( Bm , n )} \vert$$

(i.e., measuring pixel-level difference); obtaining an average of differences across all pixels within the block (i.e., yielding a block-level average difference) by mean

$$( \vert {I}^{( B , mn )} - {\hat{I}}_{S}^{( Bm , n )} \vert )$$

and obtaining a similarity between I^{(Bm,n)} and

$${\hat{I}}_{{S}^{( Bm , n )}}$$

through

$$1 - 0.5 \times mean ( \vert {I}^{( {ℬ}_{m , n} )} - {\hat{I}}_{S}^{( {ℬ}_{m , n} )} \vert )$$

(the smaller the difference, the closer the similarity approaches 1), in which the similarity between

$${I}^{( Bm , n )} and {\hat{I}}_{S}^{( Bm , n )} ;$$

is the first similarity corresponding to the image block position (m, n).

At step S605, a second similarity corresponding to the image block position is determined according to two image blocks that are in the second reconstructed training image and the first reconstructed training image and match the image block position.

In a case where the size of the second reconstructed training image is the same as the size of the first reconstructed training image, position matching may be applied for two image blocks at the same position in both the second reconstructed training image and the first reconstructed training image. These two image blocks are allowed to extend outward by a certain number of pixels according to a specific rule. In a case where the size of the second reconstructed training image is different from the size of the first reconstructed training image, the position matching may be applied for two corresponding image blocks in both the second reconstructed training image and the first reconstructed training image, that is, a correspondence between an image block in the second reconstructed training image and an image block in the first reconstructed training image is determined according to a position of each image block within the entire image of the second reconstructed training image and a position of each image block within the entire image of the first reconstructed training image.

As an example, the second similarity corresponding to the image block position is determined by the following equation:

$${sim}_{teacher} [ m , n ] = 1 - 0.5 \times mean ( \vert {\hat{I}}_{T}^{( {ℬ}_{m , n} )} - {\hat{I}}_{S}^{( {ℬ}_{m , n} )} \vert )$$

where

$${{\hat{I}}_{T}}^{( Bm , n )}$$

represents an image block at the position (m, n) in the first reconstructed training image Î_{T},

$$\hat{I} {s}^{( Bm , n )}$$

represents an image block at the position (m, n) in the second reconstructed training image Î_{S}, and sim_{teacher}[m,n] represents a second similarity corresponding to the image block position (m, n).

The meaning of the above equation may include:
calculating an absolute value of a pixel difference between

$${{\hat{I}}_{T}}^{( Bm , n )} and {{\hat{I}}_{S}}^{( Bm , n )}$$

through

$$\vert {\hat{I}}_{T}^{( Bm , n )} - {\hat{I}}_{S}^{( Bm , n )} \vert$$

(i.e., measuring a pixel-level difference); obtaining an average of differences across all pixels within the block (i.e., yielding a block-level average difference) by mean

$$( \vert {\hat{I}}_{T}^{( Bm , n )} - {\hat{I}}_{S}^{( Bm , n )} \vert ) ;$$

and obtaining a similarity between

$${\hat{I}}_{T}^{( {B}_{m , n} )} and {\hat{I}}_{S}^{( {B}_{m , n} )}$$

through

$$1 - 0.5 \times mean ( \vert {\hat{I}}_{T}^{( {B}_{m , n} )} - {\hat{I}}_{S}^{( {B}_{m , n} )} \vert )$$

(the smaller the difference, the closer the similarity approaches 1), in which the similarity between

$${\hat{I}}_{T}^{( {B}_{m , n} )} and {\hat{I}}_{S}^{( {B}_{m , n} )}$$

is the second similarity corresponding to the image block position (m, n).

At step S606, a reconstruction loss is determined according to first similarities and second similarities corresponding to a plurality of image block positions.

In some embodiments, the training image is labeled with the abnormal region. The plurality of image block positions are divided into at least one first image block position and at least one second image block position based on whether a plurality of image blocks corresponding to the training image include a pixel located in the abnormal region, in which an image block corresponding to the first image block position in the training image includes a pixel located in the abnormal region, and an image block corresponding to the second image block position in the training image does not include any pixel located in the abnormal region. For each first image block position, a first vector corresponding to the each first image block position is generated according to a first similarity and a second similarity corresponding to the each first image block position and at least one second similarity corresponding to the at least one second image block position. For each second image block position, a second vector corresponding to the each second image block position is generated according to a first similarity and a second similarity corresponding to the each second image block position and at least one first similarity corresponding to the at least one first image block position. The reconstruction loss is determined according to the first vector corresponding to at least one first vector corresponding to the at least one first image block position and at least one second vector corresponding to the at least one second image block position.

The image block in the training image including the pixel located in the abnormal region of the training image includes two scenarios. One scenario is that all pixels within the image block in the training image are pixels located in the abnormal region. Another scenario is that a part of the pixels within the image block in the training image are the pixels located in the abnormal region, while others are the pixels not located in the abnormal region.

As an example, the training image is labeled with the abnormal region. M_{gt}∈{0,1}^{(H×W)} indicates whether the pixel in the training image is located in the abnormal region, H represents the height of the training image and W represents the width of the training image. A value of M_{gt}(p) being 1 indicates that a pixel p in the training image is located in the abnormal region, and a value of M_{gt}(p) being 0 indicates that the pixel p in the training image is not in the abnormal region. Therefore, whether the image block of the training image includes the pixel in the abnormal region may be determined through the following equation:

$$\begin{matrix}{num}_{tamper} [ m , n ] = {\sum }_{p ∈ {B}_{m , n}} {M}_{g t} ( p ) , \\ {ℬ}_{border} = \{ ( m , n ) \vert 0 < {num}_{tamper} [ m , n ] < 64 \} ,\end{matrix}$$

where P∈B_{m,n} indicates that the pixel p is a pixel within an image block B_{m,n}, the image block B_{m,n} is an image block in the training image, and the number of pixels within the abnormal region within the image block B_{m,n} is calculated through [symbol] M_{gt}(p).

If numₜₐₘₚₑᵣ[m, n]=64, it indicates that all pixels within the image block B_{m,n} are located in the abnormal region. If numₜₐₘₚₑᵣ[m, n]=0, it indicates that all pixels within the image block B_{m,n} are not in the abnormal region. Therefore, [symbol] _{border}={(m, n)|0<numₜₐₘₚₑᵣ[m, n]<64} represents a border block where “both pixels within the abnormal region and pixels outside the abnormal region exist in the block”.

If the image block in the training image corresponding to the image block position (m, n) is a border block B_{border}, or an image block where numₜₐₘₚₑᵣ[m, n]=64, then the image block position (m, n) is the first image block position. If the image block in the training image corresponding to the image block position (m, n) is an image block where numₜₐₘₚₑᵣ[m, n]=0, then the image block at the image block position (m, n) is the second image block position.

As an example, if the first similarity corresponding to the first image block position is represented by sim_{image}[pos], the second similarity corresponding to the first image block position is represented by sim_{teacher}[pos], where “pos” represents the first image block position, e.g., (m, n). If the first similarity corresponding to the second image block position is represented by sim_{image}[neg], the second similarity corresponding to the second image block position is represented by sim_{teacher}[neg], where “neg” represents the second image block position, e.g., (m, n). Therefore, the first vector logitsₚₒₛ corresponding to the first image block position is represented by:

$${logits}_{pos} = [ {sim}_{teacher} [ pos ] , {sim}_{image} [ pos ] , {sim}_{teacher} [ neg ] ]$$

where sim_{teacher}[pos] is a first element of the first vector logitsₚₒₛ, sim_{image}[pos] is a second element of the first vector logitsₚₒₛ, sim_{teacher}[neg] represents third, fourth and N^{th} (N being an integer) elements of the first vector logitsₚₒₛ, which represents the at least one second similarity corresponding to the at least one second image block position.

For each first image block position, a first vector corresponding to the each first image block position may be generated. The first vector corresponding to any first image block position includes a first similarity and a second similarity corresponding to the any first image block position, and the at least one second similarity corresponding to the at least one second image block position. For example, for a first image block position pos₁, the first vector may be generated by the following equation:

$${logits}_{{pos}_{1}} = [ {sim}_{teacher} [ p o {s}_{1} ] , {sim}_{image} [ p o {s}_{1} ] , {sim}_{teacher} [ n e {g}_{1} ] , {sim}_{teacher} [ n e {g}_{2} ] ]$$

The first vector includes the first similarity sim_{image}[pos₁] and the second similarity sim_{teacher}[pos₁] corresponding to the first image block position, and second similarities sim_{teacher}[neg₁] and sim_{teacher}[neg₂] corresponding to two second image block positions.

Similarly, if the first similarity corresponding to the first image block position is represented by sim_{image}[pos], the second similarity corresponding to the first image block position is represented by sim_{teacher}[pos], where “pos” represents the first image block position, e.g., (m, n). If the first similarity corresponding to the second image block position is represented by sim_{image}[neg], the second similarity corresponding to the second image block position is represented by sim_{teacher}[neg], where “neg” represents the second image block position, e.g., (m, n). Therefore, the second vector logits_{neg} corresponding to the second image block position may be represented by:

$${logits}_{neg} = [ {sim}_{image} [ neg ] , {sim}_{teacher} [ neg ] , {sim}_{image} [ pos ] ]$$

where sim_{image}[neg] is a first element of the second vector logits_{neg}, sim_{teacher}[neg] is a second element of the second vector logits_{neg}, sim_{image}[pos] represents third, fourth and N^{th} (N being an integer) elements of the second vector logits_{neg}, which represents the at least one first similarity corresponding to the at least one first image block position.

For each second image block position, a second vector corresponding to the each second image block position may be generated. The second vector corresponding to any second image block position includes a first similarity and a second similarity corresponding to the any second image block position, and the at least one first similarity corresponding to the at least one first image block position. For example, for a second image block position neg₁, the second vector may be generated by the following equation:

$${logits}_{n e {g}_{1}} = [ {sim}_{image} [ n e {g}_{1} ] , {sim}_{teacher} [ n e {g}_{1} ] , {sim}_{image} [ p o {s}_{1} ] , {sim}_{image} [ p o {s}_{2} ] ]$$

The second vector includes the first similarity sim_{image}[neg₁] and the second similarity sim_{teacher}[neg₁] corresponding to the second image block position, and first similarities sim_{image}[pos₁], sim_{image}[pos₂] corresponding to two first image block positions.

As an example, if the first vector corresponding to the first image block position is represented by logitsₚₒₛ, where logitsₚₒₛ=|sim teacher [pos], sim image [pos], sim teacher [neg], and the second vector corresponding to the second image block position is represented by logits_{neg}, where logits_{neg}=|sim_{image}[neg], sim teacher [neg], sim_{image}[pos], a determined reconstruction loss L_{contrast} is represented by:

$${L}_{contrast} = CrossEntrophy ( {logits}_{p o s} , target = 0 ) + CrossEntrophy ( {logits}_{n e g} , target = 0 ) ,$$

where CrossEntropy(⋅, target=0) represents a cross-entropy loss, while CrossEntropy(logitsₚₒₛ, target=0) indicates that for logitsₚₒₛ, the target is that the 0^{th} element (sim_{teacher}[pos]) achieves a highest score. This means that for the image blocks corresponding to the first image block position (the image block in the training image being the image block including the pixel located in the abnormal region), the image block in the second reconstructed training image is closer to the image block in the first reconstructed training image. Similarly, CrossEntropy(logits_{neg}, target=0) indicates that for logits_{neg}, the target is the 0^{th} element (sim_{image}[neg]) achieves the highest score. That is, for the image blocks corresponding to the second image block position (the image block in the training image being the image block not including the pixel located in the abnormal region), the image block in the second reconstructed training image is closer to the image block in the training image.

When there are a plurality of first image block positions, CrossEntropy(logitsₚₒₛ, target=0) refers to calculating a cross-entropy loss for a first vector corresponding to each first image block position and obtaining a sum and an average of cross-entropy losses of the first vectors corresponding to the plurality of first image block positions, that is, CrossEntropy(logitsₚₒₛ, target=0) is an average cross-entropy loss for one type of image block positions. When there are a plurality of second image block positions, CrossEntropy(logits_{neg}, target=0) refers to calculating a cross-entropy loss for a second vector corresponding to each second image block position and obtaining a sum and an average of cross-entropy losses of the second vectors corresponding to the plurality of second image block positions, that is, CrossEntropy(logits_{neg}, target=0) is an average cross-entropy loss for another type of image block positions. The average cross-entropy losses of the two types of image block positions are added together to obtain the reconstruction loss.

In the embodiment of the disclosure, precisely locating and distinguishing for the image block position may be achieved by accurately determining whether the image block position is the first image block position (i.e., the image block in the training image including the pixel located in the abnormal region) or the second image block position (i.e., the image block in the training image not including the pixel located in the abnormal region). During vector generation, similarity features corresponding to different types of image block positions are introduced. The first vector corresponding to the first image block position is combined with the second similarity corresponding to the second image block position, while the first vector corresponding to the second image block position is combined with the first similarity corresponding to the first image block position. It enables a vector to not only include its own similarity information but also carry feature references of an opposite type, which enriches the feature dimensions carried by the vector, thereby making it more distinguishable. The reconstruction loss is determined based on the first vector and the second vector, which makes the student model focus more on feature differences between abnormal and normal regions during training, and guides the student model to learn anomaly recognition patterns more efficiently.

At step S607, the student model to be trained is trained according to the reconstruction loss.

The reconstruction loss indicates that for the image block corresponding to the first image block position (the image block in the training image being the image block including the pixel located in the abnormal region), the image block in the second reconstructed training image is closer to the image block in the first reconstructed training image, and for the image block corresponding to the second image block position (the image block in the training image being the image block not including the pixel located in the abnormal region), the image block in the second reconstructed training image is closer to the image block in the training image. Thus, in some embodiments, training the student model to be trained based on the reconstruction loss enables the student model to focus more on the feature differences between the abnormal regi on and the normal region during the training process, and guides the student model to learn the anomaly recognition patterns more efficiently.

In some embodiments, a perceptual loss is determined according to the second reconstructed training image and the training image, in which the perceptual loss is used to indicate a difference in perception features between the second reconstructed training image and the training image. A divergence loss is determined according to a latent distribution parameter output by an encoder in the student model to be trained, in which the divergence loss is used to match a latent distribution output by the encoder in the student model to be trained with a distribution to be detected. The student model to be trained is trained according to at least one of the reconstruction loss, the perceptual loss or the divergence loss.

As an example, to maintain visual quality of reconstruction, the perceptual loss is determined according to the second reconstructed training image and the training image. For example, the perceptual loss may be a learned perceptual image patch similarity (LPIPS) loss, which is represented as:

$${L}_{lpips} = LPIPS ( {\hat{I}}_{S} , I )$$

where the LPIPS loss may be obtained by calculating a perceptual distance using a pre-trained AlexNet or VGGNet.

The perceptual loss ensures that the second reconstructed training image is visually similar to the training image.

As an example, to match the latent distribution output by the encoder in the student model to be trained with the distribution to be detected, the divergence loss may be determined according to parameters of the latent distribution output by the encoder in the student model to be trained. For example, if the student model to be trained is an auto-encoder in a VAE architecture, the divergence loss may be a KL regularization divergence loss:

$${L}_{k l} = 0 \text{.5} \times \sum ( {μ}^{2} + {σ}^{2} - log ( {σ}^{2} ) - 1 )$$

where μ and σ are parameters of the latent distribution output by the encoder in the student model to be trained, μ represents a mean of the latent distribution output by the encoder in the student model to be trained, and σ represents a standard deviation of the latent distribution output by the encoder in the student model to be trained.

As an example, if the reconstruction loss is represented by L_{contrast}, the perceptual loss is represented by Lₗₚᵢₚₛ, and the divergence loss is represented by Lₖₗ, the student model to be trained is trained according to a total loss: L=L_{contrast}+λ₁×Lₗₚᵢₚₛ+λ₂×Lₖₗ,

where λ₁ is a weight of the perceptual loss, λ₂ is a weight of the divergence loss, and both λ₁ and λ₂ are within a range [0,1].

According to the model training method provided by the embodiment of the disclosure, the block processing is performed on the second reconstructed training image, the training image and the first reconstructed training image according to the preset resolution, respectively, to ensure precise spatial alignment of corresponding image blocks across different images. The first similarity between corresponding image blocks in the second reconstructed training image and the training image precisely reflects the difference between the second reconstructed training image and the real training image. The second similarity between corresponding image blocks in the second reconstructed training image and the first reconstructed training image precisely reflects the feature association between the two reconstructed images. These two similarities capture image feature information from different dimensions. The reconstruction loss is determined according to two types of similarities across the plurality of image block positions, so that it can fully reflect feature differences across at different positions and dimensions, and more precisely reflect the bias during model training. Training the student model to be trained based on the reconstruction loss may effectively guide the student model to be trained to optimize toward a desired direction.

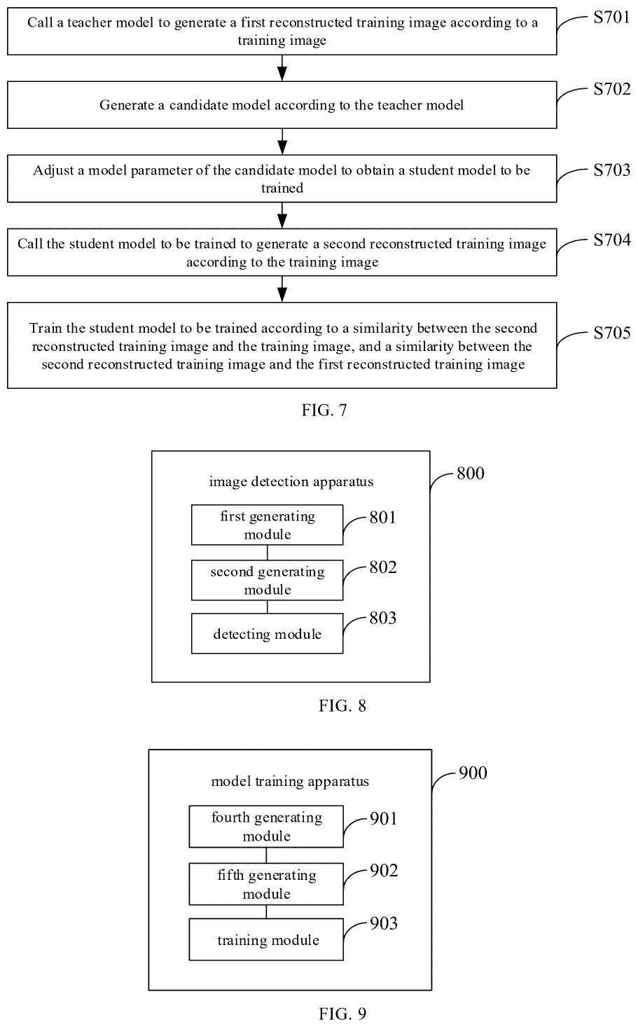

FIG. 7 is a schematic diagram of yet another model training method provided by an embodiment of the disclosure.

As illustrated in FIG. 7, the model training method includes the following steps.

At step S701, a teacher model is called to generate a first reconstructed training image according to a training image.

For description of step S701, reference may be made to the relevant description in any embodiment of the disclosure, and details may not be repeated here.

At step S702, a candidate model is generated according to the teacher model.

As an example, a copy of the teacher model may be used as the candidate model.

At step S703, a model parameter of the candidate model is adjusted to obtain a student model to be trained.

In some embodiments, a principal component parameter of any convolutional layer in the candidate model is obtained by performing high-order singular value decomposition processing on a weight of the any convolutional layer. A residual parameter of the convolutional layer is determined according to the weight and the principal component parameter of the convolutional layer. The student model to be trained is obtained by initializing the residual parameter of the convolutional layer and a scale parameter.

As an example, the following operations are performed on the any convolutional layer in the candidate model, which includes:
extracting a weight tensor: W^{(k)}=Convₖ·weight;
performing the high-order singular value decomposition processing:

$${S}^{( k )} , {\{ {U}_{i}^{( k )} \}}_{i = 1}^{4} = HOSVD ( {W}^{( k )} , η = 0.75 ) ;$$

reconstructing the principal component:

$${W}_{m a i n}^{( k )} = {S}^{( k )} {\times }_{1} {U}_{1}^{( k )} {\times }_{2} {U}_{2}^{( k )} {\times }_{3} {U}_{3}^{( k )} {\times }_{4} {U}_{4}^{( k )} ;$$

initializing a trainable residual parameter: R^{(k)}=0; and
initializing a trainable scale coefficient: α^{(k)}=0.1,
where W^{(k)}∈ [symbol] ^{(C}^{ₒᵤₜ}^{×C}^{ᵢₙ}^{×K}^{ₙ}^{×K}^{_{w}}⁾ represents a weight of the k^{th} convolutional layer, an output channel Cₒᵤₜ, an input channel Cᵢₙ, a kernel height Kₕ and a kernel width K_{w} represent four dimensions of the convolutional layer. During the high-order singular value decomposition processing, four orthogonal basis matrices

$${U}_{1}^{( k )} , {U}_{2}^{( k )} , {U}_{3}^{( k )} and {U}_{4}^{( k )}$$

are determined. Moreover, S^{(k)} represents a kernel tensor determined during the high-order singular value decomposition processing,

$${W}_{m a i n}^{( k )}$$

represents the principal component parameter obtained during the high-order singular value decomposition processing, which remains frozen (unchanged during model training), R^{(k)} represents the trainable residual parameter of the k^{th} convolutional layer, and α^{(k)} represents the trainable scale coefficient of the k^{th} convolutional layer, α^{(k)}∈ [symbol] ₊.

The final weight of each convolutional layer is calculated by:

$${R}_{⊥}^{( k )} = {R}^{( k )} - {Σ}_{i} ( {R}^{( k )} {\times }_{i} {{U}_{i}^{( k )} ( {U}_{i}^{( k )} )}^{T} ) ,$$

$${W}_{final}^{( k )} = {W}_{m a i n}^{( k )} + {α}^{( k )} \times {R}_{⊥}^{( k )} .$$

To prevent the residual parameter R^{(k)} from influencing the principal component parameter

$${W}_{m a i n}^{( k )}$$

after training, an orthogonal projection mechanism is designed.

The mechanism includes: calculating a projection of the residual parameter R^{(k)} after training towards the principal component parameter:

$${Σ}_{i} ( {R}^{( k )} {\times }_{i} {{U}_{i}^{( k )} ( {U}_{i}^{( k )} )}^{T} ) ,$$

then subtracting this portion of data from R^{(k)}, namely

$${R}^{( k )} - {Σ}_{i} ( {R}^{( k )} {\times }_{i} {{U}_{i}^{( k )} ( {U}_{i}^{( k )} )}^{T} ) ,$$

to obtain the final residual parameter

$${R}_{⊥}^{( k )} .$$

The final residual parameter

$${R}_{⊥}^{( k )}$$

may be scaled using the scale coefficient α^{(k)}, and the final weight

$${W}_{final}^{( k )}$$

is determined based on the scaled residual parameter

$${α}^{( k )} * {R}_{⊥}^{( k )}$$

and the principal component parameter

$${W}_{m a i n}^{( k )} .$$

In the embodiment of the disclosure, directly obtaining the principal component parameter by performing the high-order singular value decomposition processing on the weight of the convolutional layer enables precise extraction of the core feature structure within the weight, thereby effectively reducing the parameter dimension while preserving critical information. Calculating the residual parameter based on the initial weight and the principal component parameter captures fine-granularity features and structural details nearly omitted by the principal component, allowing the model to maintain its expression capabilities while remaining compact. By appropriately initializing the residual parameter and the scale parameter, the student model not only gains an initial state closer to the optimal solution but also balances the contribution ratio between the main component and the residual, which is beneficial to mitigating instability during early training. This initialization strategy enables the student model to converge rapidly while inheriting the core capabilities of the teacher model, and to further enhance its generalization performance.

In some embodiments, the weight of any convolutional layer in the candidate model includes a plurality of dimensions. An expansion matrix corresponding to any dimension may be obtained by expanding the weight of the convolutional layer in the candidate model in the dimension. A left singular matrix, a singular value matrix and a right singular matrix corresponding to the dimension are obtained by performing the singular value decomposition processing on the expansion matrix corresponding to the dimension. A principal component matrix corresponding to the dimension is obtained by extracting the left singular matrix corresponding to the dimension according to a preset principal component extraction coefficient and elements on a principal diagonal of the singular value matrix corresponding to the dimension. An associated tensor of the convolutional layer is determined according to a strength of association between elements in principal component matrices corresponding to the plurality of dimensions, in which each element in the associated tensor is used to indicate a strength of association between elements at a corresponding position across the plurality of dimensions. The principal component parameter of the convolutional layer is determined according to the principal component matrices corresponding to the plurality of dimensions and the associated tensor.

In the embodiment of the disclosure, the matrix corresponding to any dimension is obtained by expanding the weight of the convolutional layer in the candidate model along that dimension. The singular value decomposition processing is performed on the expanded matrix, and the elements on the principal diagonal of the singular value matrix are determined in combination with the preset principal component extraction coefficient, and then the principal component matrix is obtained through extraction. This process precisely preserves the core features within the weight that are critical to model performance, effectively filters out redundant information and noise interference to reduce the complexity of subsequent parameter calculations while ensuring the integrity and validity of core features. The associated tensor is constructed based on the strength of association between elements within the principal component matrices corresponding to the plurality of dimensions, which enables deep exploration of the intrinsic association relationships among principal components across different dimensions. The tensor elements visually represent the degree of association between elements at the corresponding position across different dimensions, which provides a clear quantitative reference for understanding the feature propagation pattern and dimensional interaction mechanism of the weight of the convolutional layer. The principal component parameter of the convolutional layer is determined based on the principal component matrices corresponding to the plurality of dimensions and the associated tensor, and thus the parameter encapsulate both the core feature information of different dimensions and integrate the association patterns across dimensions, which significantly enhances the capabilities of the model to fit and generalize complex features.

To enable the principal component parameter to possess both the single-dimensional core features and multi-dimensional associations, the core features of the principal component matrices corresponding to the plurality of dimensions are effectively integrated with the inter-dimensional association patterns embodied by the associated tensor. The associated tensor is expanded based on the principal component matrices corresponding to different dimensions sequentially in sequence of the dimensions, to obtain the principal component parameter of the convolutional layer.

At step S704, the student model to be trained is called to generate a second reconstructed training image according to the training image.

The student model to be trained is determined based on the teacher model.

At step S705, the student model to be trained is trained according to a similarity between the second reconstructed training image and the training image and a similarity between the second reconstructed training image and the first reconstructed training image.

In some embodiments, the process of training the student model to be trained may include, for example, adjusting the residual parameter of the convolutional layer in the student model to be trained and the scale parameter.

The residual parameter complements the principal component parameter of the convolutional layer, it captures fine-granularity features and structural differences not covered by the principal component. Targeted adjustment of the residual parameter enables the student model to be trained to precisely compensate for feature loss resulting from similar principal components, which further refines learning of complex image features, and prevents model fitting bias caused by missing critical details. The scale parameter directly influences the contribution ratio of the residual feature and the principal component feature in convolutional operations. Dynamically adjusting the scale parameter allows flexible changes of the weights assigned to these two types of features.

For the descriptions of steps S704-S705, reference may be made to the relevant description of any embodiment of the disclosure, and details may not be repeated here.

According to the model training method provided in the embodiment of the disclosure, the candidate model is generated based on the teacher model, the candidate model directly inherits validated feature extraction frameworks, network architecture logics and core parameter distribution patterns of the teacher model, which avoids possible occurrence of structural design biases or initial feature learning direction errors for models established from scratch, reduces foundational design costs of the student model while ensuring its feature learning latent similar to the teacher model from the start. Instead of directly using the candidate model as the student model to be trained, targeted adjustments are made to the model parameters of the candidate model. Based on the lightweight requirements, target task features (such as image recognition or anomaly detection in specific scenarios), or hardware deployment constraints of the student model, the parameters of the candidate model are pruned, optimized or adaptively adjusted, to effectively reduce the convergence time during subsequent training and reduce performance fluctuations caused by parameter changes during training, thereby providing a stable starting point for the student model to rapidly achieve an optimal training result.

Corresponding to the image detection method provided in the embodiments of FIGS. 1-3, an embodiment of the disclosure also provides an image detection apparatus. Since the image detection apparatus provided in the embodiment of the disclosure corresponds to the image detection method provided in the embodiments of FIGS. 1-3, the implementations of the image detection method are also applicable to the image detection apparatus provided in the embodiment of the disclosure, which will not be described in detail in the following embodiments.

FIG. 8 is a schematic structural diagram of an image detection apparatus 800 provided by an embodiment of the disclosure.

As illustrated in FIG. 8, the image detection apparatus 800 provided by the embodiment of the disclosure includes: a first generating module 801, a second generating module 802 and a detecting module 803.

The first generating module 801 is configured to call a teacher model to generate a first reconstructed image according to an initial image.

The second generating module 802 is configured to call a student model to generate a second reconstructed image according to the initial image, in which the student model is trained based on the teacher model and has a capability to detect an abnormal region in the image.

The detecting module 803 is configured to determine a position of the abnormal region in the initial image according to a reconstruction error between the initial image and the first reconstructed image and a reconstruction error between the initial image and the second reconstructed image.

In an embodiment of the disclosure, the detecting module 803 includes: a first determining unit, configured to determine a probability of any pixel in the initial image being located in the abnormal region according to the reconstruction error between the initial image and the first reconstructed image, and the reconstruction error between the initial image and the second reconstructed image; and a second determining unit, configured to determine the position of the abnormal region in the initial image according to the probability of the any pixel in the initial image being located in the abnormal region.

In an embodiment of the disclosure, the first determining unit is further configured to: determine a reconstruction error between a first pixel and a second pixel according to the first pixel in the initial image corresponding to a first position and the second pixel in the first reconstructed image corresponding to the first position; determine a reconstruction error between the first pixel and a third pixel according to the first pixel and the third pixel in the second reconstructed image corresponding to the first position; and determine a probability of the first pixel being located in the abnormal region according to the reconstruction error between the first pixel and the second pixel, and the reconstruction error between the first pixel and the third pixel.

In an embodiment of the disclosure, the first determining unit is further configured to: determine a reconstruction error difference of the first pixel according to the reconstruction error between the first pixel and the second pixel, and the reconstruction error between the first pixel and the third pixel; and obtain the probability of the first pixel being located in the abnormal region by performing normalization processing on the reconstruction error difference of the first pixel.

In an embodiment of the disclosure, the first determining unit is further configured to: obtain a scaled reconstruction error difference by performing a scaling processing on the reconstruction error difference of the first pixel according to a scale coefficient, in which the scale coefficient is used to indicate a degree of scaling during the scaling processing; and obtain the probability of the first pixel being located in the abnormal region by performing the normalization processing on the scaled reconstruction error difference using a normalization function.

In an embodiment of the disclosure, the second determining unit is further configured to: determine that the any pixel in the initial image is located in the abnormal region in response to the probability of the any pixel in the initial image being located in the abnormal region satisfying a first preset probability condition; and determine the position of the abnormal region in the initial image according to a position of the any pixel located in the abnormal region in the initial image.

In an embodiment of the disclosure, the first determining unit is further configured to: generate a an abnormal region masked image according to a difference between the probability of the any pixel in the initial image being located in the abnormal region and a second preset probability condition, in which the abnormal region masked image is used to indicate whether the any pixel in the initial image is located in the abnormal region; and determine the position of the abnormal region in the initial image according to the abnormal region masked image.

In an embodiment of the disclosure, the apparatus further includes: a third generating module, configured to generate a probability distribution map of the abnormal region in the initial image according to the probability of the any pixel in the initial image being located in the abnormal region.

In an embodiment of the disclosure, the teacher model includes a first encoder, a first sampler and a first decoder. The first generating module 801 is further configured to: obtain a mean and a standard deviation of a first latent distribution of the initial image by calling the first encoder to encode the initial image, in which the first latent distribution is used to indicate a distribution condition of an encoding result obtained by encoding the initial image by the first encoder; obtain a first latent representation of the initial image by calling the first sampler to sample the mean and the standard deviation of the first latent distribution of the initial image; and obtain the first reconstructed image by calling the first decoder to decode the first latent representation of the initial image.

In an embodiment of the disclosure, the first generating module 801 is further configured to: obtain a second sampling noise by calling the first sampler to adjust a first sampling noise according to the standard deviation of the first latent distribution of the initial image and a first adjustment coefficient, in which the first adjustment coefficient is used to indicate a degree of influence of the second sampling noise on the first latent representation; and call the first sampler to determine the first latent representation of the initial image according to the second sampling noise and the mean of the first latent distribution of the initial image.

In an embodiment of the disclosure, the student model includes a second encoder, a second sampler and a second decoder. The second generating module 802 is further configured to: obtain a mean and a standard deviation of a second latent distribution of the initial image by calling the second encoder to encode the initial image, in which the second latent distribution is used to indicate a distribution condition of an encoding result obtained by encoding the initial image by the second encoder; obtain a second latent representation of the initial image by calling the second sampler to sample the mean and the standard deviation of the second latent distribution of the initial image; and obtain the second reconstructed image by calling the second decoder to decode the second latent representation of the initial image.

In an embodiment of the disclosure, the second generating module 802 is further configured to: obtain a fourth sampling noise by calling the second sampler to adjust a third sampling noise according to the standard deviation of the second latent distribution of the initial image and a second adjustment coefficient, in which the second adjustment coefficient is used to indicate a degree of influence of the fourth sampling noise on the second latent representation; and call the second sampler to determine the second latent representation of the initial image according to the fourth sampling noise and the mean of the second latent distribution of the initial image.

In an embodiment of the disclosure, the apparatus further includes: a first adjusting module, configured to resize the initial image for the initial image reaching a target resolution; and a processing module, configured to normalize pixel values in the resized initial image to a target value range by performing the normalization processing on the resized initial image.

With the image detection apparatus provided in the embodiment of the disclosure, the student model is trained based on the teacher model, which allows the student model to inherit the fundamental image processing capabilities of the teacher model while focusing on learning how to detect the abnormal region in the image. Therefore, the student model achieves a significantly higher reconstruction accuracy for the abnormal region compared to the teacher model. Based on the errors between the initial image and the two reconstructed images, the abnormal and normal regions in the initial image can be accurately distinguished, and the detection method based on error comparison does not rely on complex manually labeled features. It not only enhances the accuracy of detecting the abnormal region in the image but also adapts to the detection requirements of abnormal regions across different image types.

Corresponding to the model training method provided in the embodiments of FIGS. 5-7, an embodiment of the disclosure also provides a model training apparatus. Since the model training apparatus provided in the embodiment of the disclosure corresponds to the model training method provided in the embodiments of FIGS. 5-7, the implementations of the model training method are also applicable to the model training apparatus provided in the embodiment of the disclosure, which will not be described in detail in the following embodiments.

FIG. 9 is a schematic structural diagram of a model training apparatus 900 provided by an embodiment of the disclosure.

As illustrated in FIG. 9, the model training apparatus 900 provided in the embodiment of the disclosure includes: a fourth generating module 901, a fifth generating module 902 and a training module 903.

The fourth generating module 901 is configured to call a teacher model to generate a first reconstructed training image according to a training image.

The fifth generating module 902 is configured to call a student model to be trained to generate a second reconstructed training image according to the training image, in which the student model to be trained is determined based on the teacher model.

The training module 903 is configured to train the student model to be trained according to a similarity between the second reconstructed training image and the training image and a similarity between the second reconstructed training image and the first reconstructed training image.

In an embodiment of the disclosure, the training module 903 is further configured to: obtain a plurality of image blocks by performing block processing on the second reconstructed training image, the training image and the first reconstructed training image, respectively, according to a preset resolution; determine a first similarity corresponding to an image block position according to two image blocks that are in the second reconstructed training image and the training image respectively and match the image block position; determine a second similarity corresponding to the image block position according to two image blocks that are in the second reconstructed training image and the first reconstructed training image and match the image block position; determine a reconstruction loss according to first similarities and second similarities corresponding to a plurality of image block positions; and train the student model to be trained according to the reconstruction loss.

In an embodiment of the disclosure, the abnormal region is labeled in the training image. The training module 903 is further configured to: divide the plurality of image block positions into at least one first image block position and at least one second image block position based on whether a plurality of image blocks corresponding to the training image comprise a pixel located in the abnormal region, in which an image block corresponding to the first image block position in the training image comprises a pixel located in the abnormal region, and an image block corresponding to the second image block position in the training image does not comprise any pixel located in the abnormal region; for each first image block position, generate a first vector corresponding to the each first image block position according to a first similarity and a second similarity corresponding to the each first image block position and at least one second similarity corresponding to the at least one second image block position; for each second image block position, generate a second vector corresponding to the each second image block position according to a first similarity and a second similarity corresponding to the each second image block position and at least one first similarity corresponding to the at least one first image block position; and determine the reconstruction loss according to at least one first vector corresponding to the at least one first image block position and at least one second vector corresponding to the at least one second image block position.

In an embodiment of the disclosure, the training module 903 is further configured to: determine a perceptual loss according to the second reconstructed training image and the training image, in which the perceptual loss is used to indicate a difference in perception features between the second reconstructed training image and the training image; determine a divergence loss according to a latent distribution parameter output by an encoder in the student model to be trained, in which the divergence loss is used to match a latent distribution output by the encoder in the student model to be trained with a distribution to be detected; and train the student model to be trained according to at least one of the reconstruction loss, the perceptual loss or the divergence loss.

In an embodiment of the disclosure, the apparatus further includes: a sixth generating module, configured to generate a candidate model according to the teacher model; and a second adjusting module, configured to obtain the student model to be trained by adjusting a model parameter of the candidate model.

In an embodiment of the disclosure, the second adjusting module is further configured to: obtain a principal component parameter of any convolutional layer in the candidate model by performing a HOSVD on a weight of the convolutional layer; determine a residual parameter of the convolutional layer according to the weight and the principal component parameter of the convolutional layer; and obtain the student model to be trained by initializing the residual parameter of the convolutional layer and a scale parameter.

In an embodiment of the disclosure, the weight of any convolutional layer in the candidate model includes a plurality of dimensions. The second adjusting module is further configured to: obtain an expansion matrix corresponding to any dimension by expanding the weight of the convolutional layer in the candidate model in the dimension; obtain a left singular matrix, a singular value matrix and a right singular matrix corresponding to the dimension by performing a singular value decomposition processing on the expansion matrix corresponding to the dimension; obtain a principal component matrix corresponding to the dimension by extracting the left singular matrix corresponding to the dimension according to a preset principal component extraction coefficient and elements on a principal diagonal of the singular value matrix corresponding to the dimension; determine an associated tensor of the convolutional layer according to a strength of association between elements in principal component matrices corresponding to the plurality of dimensions, in which each element in the associated tensor is used to indicate a strength of association between elements at a corresponding position across the plurality of dimensions; and determine the principal component parameter of the convolutional layer according to the principal component matrices corresponding to the plurality of dimensions and the associated tensor.

In an embodiment of the disclosure, the second adjusting module is further configured to: obtain the principal component parameter of the convolutional layer by expanding the associated tensor based on the principal component matrices corresponding to the plurality of dimensions in sequence of the plurality of dimensions.

In an embodiment of the disclosure, the training module 903 is further configured to: adjust the residual parameter of the convolutional layer in the student model to be trained and the scale parameter.

According to the model training apparatus provided in the embodiment of the disclosure, the teacher model is introduced as a reference, and the student model to be trained is enabled to not only ensures a reconstruction accuracy with training images as targets but also leverages the high-quality features and reconstruction logic of the teacher model through the first reconstructed training image, which effectively reduces an exploration cost when the student model learns independently, accelerates a model convergence speed, and shortens an overall training period.

The acquisition, storage and application of user personal information in the technical solutions disclosed herein all comply with relevant laws and regulations and do not violate public order and good morals.

According to the embodiments of the disclosure, the disclosure also provides an electronic device, a readable storage medium and a computer program product.

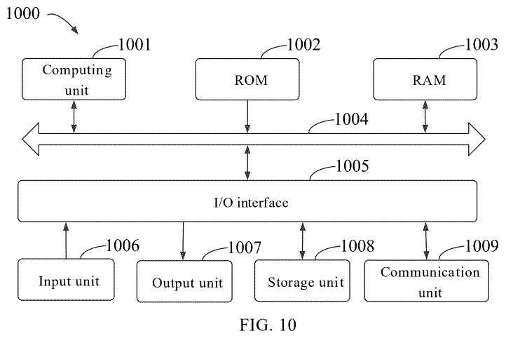

FIG. 10 is a schematic block diagram of an example electronic device 1000 that can be used to implement the embodiment of the disclosure. The electronic device is intended to represent various forms of digital computers, such as a laptop computer, a desktop computer, a workbench, a personal digital assistant, a server, a blade server, a mainframe computer and other suitable computers. The electronic device may also represent various forms of mobile devices, such as a personal digital processor, a cellular phone, a smart phone, a wearable device and other similar computing devices. The components shown here, their connections and relations, and their functions are merely exemplary, and are not intended to limit the implementations of the disclosure described and/or required herein.

As illustrated in FIG. 10, the device 1000 includes: a computing unit 1001 for performing various appropriate actions and processes according to computer programs/instructions stored in a read-only memory (ROM) 1002 or computer programs/instructions loaded from a storage unit 1008 to a random access memory (RAM) 1003. The RAM 1003 may also store necessary programs and data for the device 1000 to operate. The computing unit 1001, the ROM 1002 and the RAM 1003 are connected to each other through a bus 1004. An input/output (I/O) interface 1005 is also connected to the bus 1004.

Components in the device 1000 are connected to the I/O interface 1005, including: an input unit 1006, such as a keyboard and a mouse; an output unit 1007, such as various types of displays and speakers; the storage unit 1008, such as a disk and an optical disk; and a communication unit 1009, such as a network card, a modem and a wireless communication transceiver. The communication unit 1009 allows the device 1000 to exchange information/data with other devices through a computer network such as the Internet and/or various telecommunication networks.

The computing unit 1001 may be various general-purpose and/or dedicated processing components having processing and computing capabilities. Some examples of the computing unit 1001 include, but are not limited to, a central processing unit (CPU), a graphics processing unit (GPU), various dedicated AI computing chips, various computing units that run machine learning (ML) model algorithms, a digital signal processor (DSP) and any appropriate processor, controller or microcontroller. The computing unit 1001 executes the various methods and processes described above, such as the image detection method or the model training method. For example, in some embodiments, the image detection method or the model training method may be implemented as a computer software program, which is tangibly contained in a machine readable medium, such as the storage unit 1008. In some embodiments, part or all of the computer programs/instructions may be loaded and/or installed on the device 1000 via the ROM 1002 and/or the communication unit 1009. When the computer programs/instructions are loaded on the RAM 1003 and executed by the computing unit 1001, one or more steps of the image detection method are executed. Alternatively, in other embodiments, the computing unit 1001 may be configured to perform the image detection method or the model training method in any other suitable manner (for example, by means of firmware).

Various implementations of the systems and techniques described above may be implemented by a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware/firmware/software, and/or any combination thereof. These implementations may be implemented in one or more computer programs/instructions, the one or more computer programs/instructions may be executed and/or interpreted on a programmable system including at least one programmable processor, which may be a dedicated or general programmable processor for receiving data and instructions from a storage system, at least one input device and at least one output device, and transmitting data and instructions to the storage system, the at least one input device and the at least one output device.

The program code configured to implement the method of the disclosure may be written in any combination of one or more programming languages. These program codes may be provided to a processor/controller of a general-purpose computer, a dedicated computer or any other programmable data processing device, so that when the program code is executed by the processor/controller, the functions/operations specified in the flowchart and/or block diagram can be implemented. The program code may be executed entirely on the machine, partly executed on the machine, partly executed on the machine and partly executed on the remote machine as an independent software package, or executed entirely on the remote machine or a server.

In the context of the disclosure, a machine-readable medium may be a tangible medium that may contain or store programs for use by or in combination with an instruction execution system, an apparatus or a device. The machine-readable medium may be a machine-readable signal medium or a machine-readable storage medium. The machine-readable medium includes, but is not limited to, an electronic, magnetic, optical, electromagnetic, infrared, or semiconductor system/apparatus/device, or any suitable combination of the above. More specific examples of the machine-readable storage medium include an electrical connection based on one or more wires, a portable computer disk, a hard disk, a RAM, a ROM, an electrically programmable ROM (EPROM) or a flash memory, a fiber optic, a Compact Disc ROM (CD-ROM), an optical storage device, a magnetic storage device, or any suitable combination of the foregoing.

In order to provide interaction with a user, the systems and techniques described herein may be implemented on a computer having a display device (e.g., a cathode ray tube (CRT) or a liquid crystal display (LCD) monitor) for displaying information to a user; and a keyboard and a pointing device (such as a mouse or a trackball) through which the user can provide input to the computer. Other kinds of devices may also be used to provide interaction with the user. For example, feedback provided to the user may be any form of sensory feedback (e.g., visual feedback, auditory feedback or haptic feedback), and the input from the user may be received in any form (including acoustic input, voice input or tactile input).

The systems and technologies described herein can be implemented in a computing system that includes back-end components (for example, a data server), a computing system that includes middleware components (for example, an application server), a computing system that includes front-end components (for example, a user computer with a graphical user interface or a web browser, through which the user can interact with the implementations of the systems and technologies described herein), or a computing system that includes any combination of such back-end components, middleware components and front-end components. The components of the system may be interconnected by any form or medium of digital data communication (e.g., a communication network). The communication network may include, for example, a local area network (LAN), a wide area network (WAN), the Internet and a block-chain network.

The computer system may include a client and a server. The client and the server are generally remote from each other and interacting through a communication network. The client-server relation is generated by computer programs/instructions running on the respective computers and having a client-server relation with each other. The server may be a cloud server, a server with a distributed system, or a server combined with a block-chain.

It is understandable that the steps can be reordered, added or deleted using various forms of the processes shown above. For example, the steps in the disclosure may be performed in parallel, sequentially or in different orders, as long as the desired result of the technical solution disclosed in the disclosure is achieved, which is not limited herein.

The implementations described above do not constitute a limitation on the scope of protection of the disclosure. It should be understood by those skilled in the art that various modifications, combinations, sub-combinations and substitutions can be made according to the design requirements and other factors. Any modifications, equivalent substitutions and improvements made within the spirit and principles of the disclosure shall be included in the scope of protection of the disclosure.

What is claimed is:

1. An image detection method, comprising:
calling a teacher model to generate a first reconstructed image according to an initial image;
calling a student model to generate a second reconstructed image according to the initial image, wherein the student model is trained based on the teacher model and has a capability to detect an abnormal region in the image; and
determining a position of the abnormal region in the initial image according to a reconstruction error between the initial image and the first reconstructed image and a reconstruction error between the initial image and the second reconstructed image.

2. The method of claim 1, wherein determining the position of the abnormal region in the initial image according to the reconstruction error between the initial image and the first reconstructed image and the reconstruction error between the initial image and the second reconstructed image comprises:
determining a probability of any pixel in the initial image being located in the abnormal region according to the reconstruction error between the initial image and the first reconstructed image and the reconstruction error between the initial image and the second reconstructed image; and
determining the position of the abnormal region in the initial image according to the probability of the any pixel in the initial image being located in the abnormal region.

3. The method of claim 2, wherein determining the probability of the any pixel in the initial image being located in the abnormal region according to the reconstruction error between the initial image and the first reconstructed image and the reconstruction error between the initial image and the second reconstructed image comprises:
determining a reconstruction error between a first pixel and a second pixel according to the first pixel in the initial image corresponding to a first position and the second pixel in the first reconstructed image corresponding to the first position;
determining a reconstruction error between the first pixel and a third pixel according to the first pixel and the third pixel in the second reconstructed image corresponding to the first position; and
determining a probability of the first pixel being located in the abnormal region according to the reconstruction error between the first pixel and the second pixel and the reconstruction error between the first pixel and the third pixel.

4. The method of claim 3, wherein determining the probability of the first pixel being located in the abnormal region according to the reconstruction error between the first pixel and the second pixel and the reconstruction error between the first pixel and the third pixel comprises:
determining a reconstruction error difference of the first pixel according to the reconstruction error between the first pixel and the second pixel and the reconstruction error between the first pixel and the third pixel; and
obtaining the probability of the first pixel being located in the abnormal region by performing normalization processing on the reconstruction error difference of the first pixel.

5. The method of claim 4, wherein obtaining the probability of the first pixel being located in the abnormal region by performing the normalization processing on the reconstruction error difference of the first pixel comprises:
obtaining a scaled reconstruction error difference by performing a scaling processing on the reconstruction error difference of the first pixel according to a scale coefficient, wherein the scale coefficient indicates a degree of scaling during the scaling processing; and
obtaining the probability of the first pixel being located in the abnormal region by performing the normalization processing on the scaled reconstruction error difference using a normalization function.

6. The method of claim 2, wherein determining the position of the abnormal region in the initial image according to the probability of the any pixel in the initial image being located in the abnormal region comprises at least one of:
determining that the any pixel in the initial image is located in the abnormal region in response to the probability of the any pixel in the initial image being located in the abnormal region satisfying a first preset probability condition, and determining the position of the abnormal region in the initial image according to a position of the any pixel located in the abnormal region in the initial image; or
generating an abnormal region masked image according to a difference between the probability of the any pixel in the initial image being located in the abnormal region and a second preset probability condition, wherein the abnormal region masked image is used to indicate whether the any pixel in the initial image is located in the abnormal region, and determining the position of the abnormal region in the initial image according to the abnormal region masked image.

7. The method of claim 2, further comprising:
generating a probability distribution map of the abnormal region in the initial image according to the probability of the any pixel in the initial image being located in the abnormal region.

8. The method of claim 1, wherein at least one of the following is applied:
the teacher model comprises a first encoder, a first sampler and a first decoder, and calling the teacher model to generate the first reconstructed image according to the initial image comprises:
obtaining a mean and a standard deviation of a first latent distribution of the initial image by calling the first encoder to encode the initial image, wherein the first latent distribution is used to indicate a distribution condition of an encoding result obtained by encoding the initial image by the first encoder;
obtaining a first latent representation of the initial image by calling the first sampler to sample the mean and the standard deviation of the first latent distribution of the initial image; and
obtaining the first reconstructed image by calling the first decoder to decode the first latent representation of the initial image;
or,
the student model comprises a second encoder, a second sampler and a second decoder, and calling the student model to generate the second reconstructed image according to the initial image comprises:
obtaining a mean and a standard deviation of a second latent distribution of the initial image by calling the second encoder to encode the initial image, wherein the second latent distribution indicates a distribution condition of an encoding result obtained by encoding the initial image by the second encoder;
obtaining a second latent representation of the initial image by calling the second sampler to sample the mean and the standard deviation of the second latent distribution of the initial image; and
obtaining the second reconstructed image by calling the second decoder to decode the second latent representation of the initial image.

9. The method of claim 8, wherein obtaining the first latent representation of the initial image by calling the first sampler to sample the mean and the standard deviation of the first latent distribution of the initial image comprises:
obtaining a second sampling noise by calling the first sampler to adjust a first sampling noise according to the standard deviation of the first latent distribution of the initial image and a first adjustment coefficient, wherein the first adjustment coefficient indicates a degree of influence of the second sampling noise on the first latent representation; and
calling the first sampler to determine the first latent representation of the initial image according to the second sampling noise and the mean of the first latent distribution of the initial image.

10. The method of claim 8, wherein obtaining the second latent representation of the initial image by calling the second sampler to sample the mean and the standard deviation of the second latent distribution of the initial image comprises:
obtaining a fourth sampling noise by calling the second sampler to adjust a third sampling noise according to the standard deviation of the second latent distribution of the initial image and a second adjustment coefficient, wherein the second adjustment coefficient indicates a degree of influence of the fourth sampling noise on the second latent representation; and
calling the second sampler to determine the second latent representation of the initial image according to the fourth sampling noise and the mean of the second latent distribution of the initial image.

11. The method of claim 1, wherein before calling the teacher model to generate the first reconstructed image according to the initial image, the method further comprises:
resizing the initial image for the initial image reaching a target resolution; and
normalizing pixel values in the resized initial image to a target value range by performing the normalization processing on the resized initial image.

12. A model training method, applicable for the image detection method according to claim 1, comprising:
calling a teacher model to generate a first reconstructed training image according to a training image;
calling a student model to be trained to generate a second reconstructed training image according to the training image, wherein the student model to be trained is determined based on the teacher model; and
training the student model to be trained according to a similarity between the second reconstructed training image and the training image and a similarity between the second reconstructed training image and the first reconstructed training image.

13. The method of claim 12, wherein training the student model to be trained according to the similarity between the second reconstructed training image and the training image and the similarity between the second reconstructed training image and the first reconstructed training image comprises:
obtaining a plurality of image blocks by performing block processing on the second reconstructed training image, the training image and the first reconstructed training image, respectively, according to a preset resolution;
determining a first similarity corresponding to an image block position according to two image blocks that are in the second reconstructed training image and the training image respectively and match the image block position;
determining a second similarity corresponding to the image block position according to two image blocks that are in the second reconstructed training image and the first reconstructed training image and match the image block position;
determining a reconstruction loss according to first similarities and second similarities corresponding to a plurality of image block positions; and
training the student model to be trained according to the reconstruction loss.

14. The method of claim 13, wherein the training image is labeled with the abnormal region, and determining the reconstruction loss according to the first similarities and the second similarities corresponding to the plurality of image block positions comprises:
dividing the plurality of image block positions into at least one first image block position and at least one second image block position based on whether a plurality of image blocks corresponding to the training image comprise a pixel located in the abnormal region, wherein an image block corresponding to the first image block position in the training image comprises a pixel located in the abnormal region, and an image block corresponding to the second image block position in the training image does not comprise any pixel located in the abnormal region;
for each first image block position, generating a first vector corresponding to the each first image block position according to a first similarity and a second similarity corresponding to the each first image block position and at least one second similarity corresponding to the at least one second image block position;
for each second image block position, generating a second vector corresponding to the each second image block position according to a first similarity and a second similarity corresponding to the each second image block position and at least one first similarity corresponding to the at least one first image block position; and
determining the reconstruction loss according to at least one first vector corresponding to the at least one first image block position and at least one second vector corresponding to the at least one second image block position.

15. The method of claim 13, wherein training the student model to be trained according to the reconstruction loss comprises:
determining a perceptual loss according to the second reconstructed training image and the training image, wherein the perceptual loss is used to indicate a difference in perception features between the second reconstructed training image and the training image;
determining a divergence loss according to a latent distribution parameter output by an encoder in the student model to be trained, wherein the divergence loss is used to match a latent distribution output by the encoder in the student model to be trained with a distribution to be detected; and
training the student model to be trained according to at least one of the reconstruction loss, the perceptual loss or the divergence loss.

16. The method of claim 12, further comprising:
generating a candidate model according to the teacher model; and
obtaining the student model to be trained by adjusting a model parameter of the candidate model.

17. The method of claim 16, wherein obtaining the student model to be trained by adjusting the model parameter of the candidate model comprises:
obtaining a principal component parameter of any convolutional layer in the candidate model by performing a high-order singular value decomposition processing on a weight of the convolutional layer;
determining a residual parameter of the convolutional layer according to the weight and the principal component parameter of the convolutional layer; and
obtaining the student model to be trained by initializing the residual parameter of the convolutional layer and a scale parameter.

18. The method of claim 17, wherein the weight of any convolutional layer in the candidate model comprises a plurality of dimensions, and obtaining the principal component parameter of the convolutional layer in the candidate model by performing the high-order singular value decomposition processing on the weight of the convolutional layer comprises:
obtaining an expansion matrix corresponding to any dimension by expanding the weight of the convolutional layer in the candidate model in the dimension;
obtaining a left singular matrix, a singular value matrix and a right singular matrix corresponding to the dimension by performing a singular value decomposition processing on the expansion matrix corresponding to the dimension;
obtaining a principal component matrix corresponding to the dimension by extracting the left singular matrix corresponding to the dimension according to a preset principal component extraction coefficient and elements on a principal diagonal of the singular value matrix corresponding to the dimension;
determining an associated tensor of the convolutional layer according to a strength of association between elements in principal component matrices corresponding to the plurality of dimensions, wherein each element in the associated tensor is used to indicate a strength of association between elements at a corresponding position across the plurality of dimensions; and
determining the principal component parameter of the convolutional layer according to the principal component matrices corresponding to the plurality of dimensions and the associated tensor.

19. An electronic device, comprising:
at least one processor; and
a memory communicatively connected with the at least one processor;
wherein the memory stores instructions executable by the at least one processor, and when the instructions are executed by the at least one processor, the at least one processor is caused to implement an image detection method, and the method comprises:
calling a teacher model to generate a first reconstructed image according to an initial image;
calling a student model to generate a second reconstructed image according to the initial image, wherein the student model is trained based on the teacher model and has a capability to detect an abnormal region in the image; and
determining a position of the abnormal region in the initial image according to a reconstruction error between the initial image and the first reconstructed image and a reconstruction error between the initial image and the second reconstructed image.

20. A non-transitory computer-readable storage medium for storing computer instructions, wherein the computer instructions are used to cause a computer to implement an image detection method, and the method comprises:
calling a teacher model to generate a first reconstructed image according to an initial image;
calling a student model to generate a second reconstructed image according to the initial image, wherein the student model is trained based on the teacher model and has a capability to detect an abnormal region in the image; and
determining a position of the abnormal region in the initial image according to a reconstruction error between the initial image and the first reconstructed image and a reconstruction error between the initial image and the second reconstructed image.
